(19) United States
(12) Patent Application Publication
(10) Pub. No.: US 2024/0422603 A1
(43) Pub. Date: Dec. 19, 2024

(54) METHOD AND DEVICE FOR CONFIGURING CELL AREA IN COMMUNICATION SYSTEM

(71) Applicant: ELECTRONICS AND TELECOMMUNICATIONS RESEARCH INSTITUTE, Daejeon (KR)

(72) Inventor: Ji Hyung KIM, Daejeon (KR)

(73) Assignee: ELECTRONICS AND TELECOMMUNICATIONS RESEARCH INSTITUTE, Daejeon (KR)

(21) Appl. No.: 18/704,858

(22) PCT Filed: Oct. 12, 2022
(86) PCT No.: PCT/KR2022/015424

§ 371 Date: Apr. 25, 2024

(30) Foreign Application Priority Data
Oct. 29, 2021 (KR) 10-2021-0146779
Sep. 15, 2022 (KR) 10-2022-0116299

(51) Int. Cl. H04W 24/10; H04W 36/00

(52) U.S. Cl. CPC H04W 24/10; H04W 36/0058

(57) ABSTRACT

A technology for configuring a cell area in a communication system is disclosed. Provided may be an operation method of a first air transport device of a communication system, the method comprising the steps of: forming a cell in an aerial area; broadcasting first cell configuration information of the cell; receiving destination information from a second air transport device accessed on the basis of the first cell configuration information; changing a cell area on the basis of the destination information; and providing a communication service to the second air transport device by using the changed cell area.

### TECHNICAL FIELD

The present disclosure relates to a cell coverage configuration technique in a communication system, and more particularly, to a cell coverage configuration technique in a communication system, which is capable of flexibly configuring a cell coverage in three dimensional spatial mobile communication.

### BACKGROUND ART

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies. In addition, as a wireless communication technology, there is a spatial mobile communication technology for providing mobile communication services to various aerial vehicles such as urban air mobilities (UAMs), drones, and aircrafts.

Such the spatial mobile communication technology may be required in preparation for a communication interruption that may occur in cellular shadow areas such as mountainous areas, desert areas, island areas, and the sea, and in areas where a terrestrial network collapses due to various disasters such as earthquakes, tsunamis, and wars. Since the spatial mobile communication network is maintained even when the terrestrial network collapses due to a disaster, a disaster area may not be disconnected from the outside, making it possible to maintain individual survival and safety. In addition, the spatial mobile communication technology may be required for the establishment of a hyper-connected society by providing mobile communication services even in areas where communication was not possible, such as mountainous areas and remote areas without a communication infrastructure. A non-terrestrial network (NTN) deployed for such the spatial mobile communication system may have a difference in cell configuration from terrestrial communication. Therefore, a method of configuring a cell and a method of configuring a cell coverage which are suitable for the spatial mobile communication system, may be required.

### DISCLOSURE

### Technical Problem

The present disclosure is directed to providing a method and an apparatus for cell coverage configuration in a communication system, which is capable of flexibly configuring a cell coverage in three dimensional spatial mobile communication.

### Technical Solution

An operation method of a first aerial vehicle in a communication system, according to a first exemplary embodiment of the present disclosure for achieving the above-described objective, may comprise: forming a cell in an air region; broadcasting first cell configuration information of the cell; receiving destination information from a second aerial vehicle connected based on the first cell configuration information; changing a cell coverage based on the destination information; and providing a communication service to the second aerial vehicle using the changed cell coverage.

The first cell configuration information may include at least one of a center position parameter, a center angle parameter, a radius parameter, a maximum transmission power parameter, a maximum altitude parameter, a minimum altitude parameter, or combinations thereof.

The changing of the cell coverage based on the destination information may comprise: determining whether a destination of the second aerial vehicle according to the destination information is located in a side shadow region; in response to determining that the destination is located in the side shadow region, changing the cell coverage by rotating the cell coverage.

The changing of the cell coverage based on the destination information may comprise: determining whether a destination of the second aerial vehicle according to the destination information is located in a remote shadow region; and in response to determining that the destination is located in the remote shadow region, changing the cell coverage by increasing a transmission power of a beam directed to the destination in the cell coverage.

The operation method may further comprise: receiving location information from a third aerial vehicle connected based on the first cell configuration information; determining whether a beam directed to the third aerial vehicle needs to be changed based on the location information according to the change of the cell coverage; in response to determining that the beam needs to be changed, changing the beam to a beam directed to the third aerial vehicle in the changed cell coverage; notifying the changed beam to the third aerial vehicle; and providing a communication service to the third aerial vehicle using the changed beam.

The operation method may further comprise: receiving a cell reduction request from a fourth aerial vehicle connected to a neighboring cell; and reducing the cell coverage by reducing a transmission power of a beam directed to the fourth aerial vehicle according to the cell reduction request.

The operation method may further comprise: receiving second cell configuration information from a fifth aerial vehicle forming a neighboring cell; determining a degree of interference with the neighboring cell based on the second cell configuration information; and in response to determining that the degree of interference is greater than or equal to a threshold, changing the cell coverage by reducing a cell coverage adjacent to the neighboring cell.

The operation method may further comprise: receiving bandwidth part (BWP) information from the fifth aerial vehicle; and using a BWP different from a BWP used by the fifth aerial vehicle based on the BWP information.

The operation method may further comprise: receiving, from a sixth aerial vehicle forming a neighboring cell, a cell coverage extension request including information on a terminal being served; and extending the cell coverage by increasing a transmission power of a beam directed to the terminal being served based on the information on the terminal being served.

An operation method of a first aerial vehicle in a communication system, according to a second exemplary embodiment of the present disclosure for achieving the above-described objective, may comprise: receiving, from a second aerial vehicle, first cell configuration information of a configured cell; connecting with the second aerial vehicle based on the first cell configuration information; and requesting a cell coverage change from the second aerial vehicle based on the first cell configuration information while moving to a destination.

The requesting of the cell coverage change from the second aerial vehicle based on the first cell configuration information while moving to the destination may comprise: determining whether the destination is located in a shadow region based on the first cell configuration information; in response to determining that the destination is located in the shadow region, determining that the cell coverage needs to be changed; and requesting the cell coverage change by transmitting destination information to the second aerial vehicle.

The operation method may further comprise: measuring a received signal strength with respect to a third aerial vehicle; and requesting cell coverage reduction from the third aerial vehicle when the received signal strength is greater than or equal to a threshold.

The operation method may further comprise: receiving, from the second aerial vehicle, third cell configuration information of a cell configured by a fourth aerial vehicle; receiving, from the second aerial vehicle, a request of handover to the fourth aerial vehicle; and performing handover to the fourth aerial vehicle according to the request of handover.

A first aerial vehicle in a communication system, according to a third exemplary embodiment of the present disclosure for achieving the above-described objective, may comprise: a processor; a memory electronically communicating with the processor; and instructions stored in the memory, wherein when executed by the processor, the instructions cause the first aerial vehicle to perform: forming a cell in an air region; broadcasting first cell configuration information of the cell; receiving destination information from a second aerial vehicle connected based on the first cell configuration information; changing a cell coverage based on the destination information; and providing a communication service to the second aerial vehicle using the changed cell coverage.

In the changing of the cell coverage based on the destination information, the instructions may further cause the first aerial vehicle to perform: determining whether a destination of the second aerial vehicle according to the destination information is located in a side shadow region; and in response to determining that the destination is located in the side shadow region, changing the cell coverage by rotating the cell coverage.

The instructions may further cause the first aerial vehicle to perform: receiving location information from a third aerial vehicle connected based on the first cell configuration information; determining whether a beam directed to the third aerial vehicle needs to be changed based on the location information according to the change of the cell coverage; in response to determining that the beam needs to be changed, changing the beam to a beam directed to the third aerial vehicle in the changed cell coverage; notifying the changed beam to the third aerial vehicle; and providing a communication service to the third aerial vehicle using the changed beam.

The instructions may further cause the first aerial vehicle to perform: receiving a cell reduction request from a fourth aerial vehicle connected to a neighboring cell; and reducing the cell coverage by reducing a transmission power of a beam directed to the fourth aerial vehicle according to the cell reduction request.

### Advantageous Effects

According to the present disclosure, a terrestrial base station or an aerial vehicle spaced apart from the ground within a predetermined distance may form a cell toward a direction in which altitude increases. In addition, according to the present disclosure, an aerial vehicle spaced apart from the ground by a predetermined distance or more may form a cell toward a direction in which altitude decreases.

In addition, according to the present disclosure, a terrestrial base station or an aerial vehicle spaced apart from the ground within a predetermined distance may track movement of an aerial vehicle being served and change a cell coverage to provide communication services to a region to which the aerial vehicle being served moves. In addition, according to the present disclosure, a terrestrial base station or an aerial vehicle spaced apart from the ground within a predetermined distance may reduce a cell coverage in order to avoid interference from a neighboring cell.

In addition, according to the present disclosure, a terrestrial base station or an aerial vehicle spaced apart from the ground within a predetermined distance may form a group beam by grouping beams having the same transmission power. In addition, according to the present disclosure, a terrestrial base station or an aerial vehicle spaced apart from the ground within a predetermined distance may configure a multi-cell coverage by differently configuring a bandwidth part (BWP) for each group beam.

### DESCRIPTION OF DRAWINGS

FIG. 1 is a conceptual diagram illustrating a first exemplary embodiment of a spatial mobile communication network.

FIG. 2 is a conceptual diagram illustrating a second exemplary embodiment of a spatial mobile communication network.

FIG. 3 is a conceptual diagram illustrating a third exemplary embodiment of a spatial mobile communication network.

FIG. 4 is a conceptual diagram illustrating a fourth exemplary embodiment of a spatial mobile communication network.

FIG. 5 is a conceptual diagram illustrating a fifth exemplary embodiment of a spatial mobile communication network.

FIG. 6 is a block diagram illustrating a first exemplary embodiment of entities constituting a spatial mobile communication network.

FIG. 7 is a conceptual diagram illustrating a first exemplary embodiment of a cell configuration method in a communication system.

FIG. 8 is a conceptual diagram illustrating a second exemplary embodiment of a cell configuration method in a communication system.

FIGS. 9A and 9B are conceptual diagrams illustrating a third exemplary embodiment of a cell configuration method in a communication system.

FIGS. 10A and 10B are conceptual diagrams illustrating a fourth exemplary embodiment of a cell configuration method in a communication system.

FIGS. 11A and 11B are conceptual diagrams illustrating a fifth exemplary embodiment of a cell configuration method in a communication system.

FIGS. 12A and 12B are conceptual diagrams illustrating a sixth exemplary embodiment of a cell configuration method in a communication system.

FIG. 13 is a conceptual diagram illustrating a seventh exemplary embodiment of a cell configuration method in a communication system.

FIG. 14 is a conceptual diagram illustrating an eighth exemplary embodiment of a cell configuration method in a communication system.

FIG. 15 is a sequence chart illustrating a first exemplary embodiment of a cell coverage configuration method in a communication system.

FIG. 16 is a sequence chart illustrating a second exemplary embodiment of a cell coverage configuration method in a communication system.

### MODE OF INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

A communication network to which exemplary embodiments according to the present disclosure are applied will be described. The communication network may be a non-terrestrial network (NTN), a 4G communication network (e.g., long-term evolution (LTE) communication network), a 5G communication network (e.g., new radio (NR) communication network), a 6G communication network, and/or the like. The NTN may include a spatial mobile communication network. The 4G communication network, 5G communication network, and 6G communication network may be classified as terrestrial networks.

The NTN may operate based on the LTE technology and/or NR technology. The NTN may support communication in a frequency band of 6 GHz or above as well as a frequency band of 6 GHz or below. The 4G communication network may support communications in a frequency band of 6 GHz or below. The 5G communication network may support communications not only in a frequency band of 6 GHz or below, but also in a frequency band of 6 GHz or above. A communication network to which exemplary embodiments according to the present disclosure are applied is not limited to the contents described below, and exemplary embodiments according to the present disclosure may be applied to various communication networks. Here, a communication network may be used in the same meaning as a communication system.

Throughout the present disclosure, a ‘network’ may include, for example, a wireless Internet such as Wi-Fi, a portable Internet such as wireless broadband internet (WiBro) or world interoperability for microwave access (WiMax), a 3rd generation (3G) mobile communication network such as global system for mobile communication (GSM), code division multiple access (CDMA), or CDMA2000, a 3.5th generation (3.5G) mobile communication network such as high speed downlink packet access (HSDPA) or high speed uplink packet access (HSUPA), a 4th generation (4G) mobile communication network such as long term evolution (LTE) or LTE-Advanced, a 5th generation (5G) mobile communication network, 6th generation (6G) mobile communication network, and/or the like.

Throughout the present disclosure, a ‘terminal’ may refer to a mobile station, mobile terminal, subscriber station, portable subscriber station, user equipment, access terminal, and/or the like, and may include all or some functions of the terminal, mobile station, mobile terminal, subscriber station, portable subscriber station, user equipment, access terminal, and/or the like.

The terminal may refer to a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video player, or the like that has communication capability and that a mobile communication service user can use.

Throughout the present disclosure, a ‘base station’ may refer to an access point, radio access station, NodeB, evolved NodeB, base transceiver station, mobile multi-hop relay-base station (MMR-BS), and/or the like, and may include all or some functions of the base station, access point, wireless access station, NodeB, evolved NodeB, base transceiver station, MMR-BS, and/or the like.

Hereinafter, exemplary embodiments will be described with reference to the 3GPP NR mobile communication system, and the following references ([1] to [8]) that define the operations of the 3GPP NR mobile communication system may be cited.
Reference [1] 3GPP TS 38.211 V15.5.0, “3rd Generation Partnership Project; Technical Specification Group Radio Access Network; NR; Physical channels and modulation (Release 15)” Mar. 2019.
Reference [2] 3GPP TS 38.212 V15.5.0, “3rd Generation Partnership Project; Technical Specification Group Radio Access Network; NR; Multiplexing and channel coding (Release 15)” Mar. 2019.
Reference [3] 3GPP TS 38.213 V15.5.0, “3rd Generation Partnership Project; Technical Specification Group Radio Access Network; NR; Physical layer procedures for data (Release 15)”, March 2019.
Reference [4] 3GPP TS 38.214 V15.5.0, “3rd Generation Partnership Project; Technical Specification Group Radio Access Network; NR; Physical layer procedures for data (Release 15)”, March 2019.
Reference [5] 3GPP TS 38.331 V15.5.1, “3rd Generation Partnership Project; Technical Specification Group Radio Access Network; NR; Radio Resource Control (RRC) protocol specification (Release 15)”, March 2019.
Reference [6] 3GPP TR 38.811 V15.0.0, “3rd Generation Partnership Project; Technical Specification Group Radio Access Network; Study on New Radio (NR) to support non terrestrial networks (Release 15)”, June. 2018.
Reference [7] 3GPP TS 38.821 V0.4.0, “3rd Generation Partnership Project; Technical Specification Group Radio Access Network; Solutions for NR to support non-terrestrial networks (NTN) (Release 16)”, March 2019.
Reference [8] 3GPP TR 22.829 V1.0.0, “3rd Generation Partnership Project; Technical Specification Group Radio Access Network; Study on Enhancement for Unmanned Aerial Vehicles; Stage 1 (Release 17)”, March 2019.

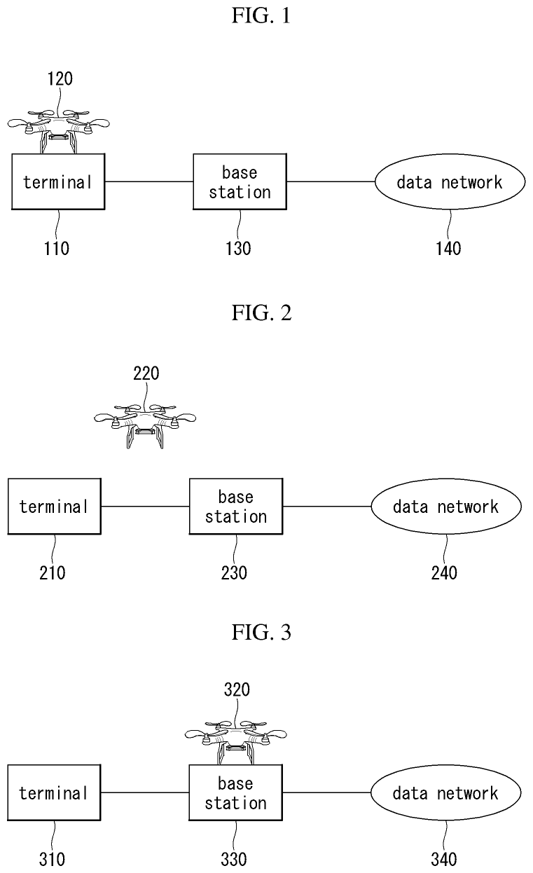

FIG. 1 is a conceptual diagram illustrating a first exemplary embodiment of a spatial mobile communication network.

Referring to FIG. 1, a spatial mobile communication network may include a terminal 110, an aerial vehicle 120, a base station 130, and a data network 140. In such the spatial mobile communication network, the terminal 110 may be installed in the aerial vehicle 120, and may communicate with the base station 130.

FIG. 2 is a conceptual diagram illustrating a second exemplary embodiment of a spatial mobile communication network.

Referring to FIG. 2, a spatial mobile communication network may include a terminal 210, an aerial vehicle 220, a base station 230, and a data network 240. Such the spatial mobile communication network may be implemented in a structure where a non-terrestrial base station is installed in the aerial vehicle 220 between the terminal 210 and the base station 230 to relay communications between the terminal 210 and the base station 230.

FIG. 3 is a conceptual diagram illustrating a third exemplary embodiment of a spatial mobile communication network.

Referring to FIG. 3, a spatial mobile communication network may include a terminal 310, an aerial vehicle 320, a base station 330, and a data network 340. Such the spatial mobile communication network may be implemented in a structure where a non-terrestrial base station installed in the aerial vehicle 320 performs some or all of functions of the base station 330 so that the terminal 310 and the base station 330 perform communications.

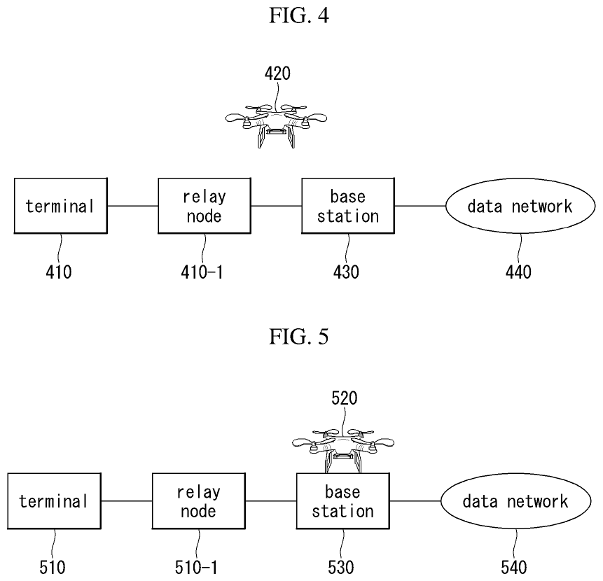

FIG. 4 is a conceptual diagram illustrating a fourth exemplary embodiment of a spatial mobile communication network.

Referring to FIG. 4, a spatial mobile communication network may include a terminal 410, a relay node 410-1, an aerial vehicle 420, a base station 430, and a data network 440. Such the spatial mobile communication network may be implemented in a structure where a non-terrestrial base station is installed in the aerial vehicle 420 between the relay node 410-1 and the base station 430 to relay communications.

FIG. 5 is a conceptual diagram illustrating a fifth exemplary embodiment of a spatial mobile communication network.

Referring to FIG. 5, a spatial mobile communication network may include a terminal 510, a relay node 510-1, an aerial vehicle 520, a base station 530, and a data network 540. Such the spatial mobile communication network may be implemented in a structure where a non-terrestrial base station installed in the aerial vehicle 520 performs some or all of functions of the base station 530 so that the relay node 510-1 and the base station 530 perform communications.

As described above, the spatial mobile communication network may be designed in a structure in which a terminal performs wireless communication using an aerial vehicle located in the air. Here, the aerial vehicle may be an unmanned aerial vehicle (UAV). The unmanned aerial vehicle may include the satellite or high-altitude platform station system (HAPS) of Reference [6]. In addition, the unmanned aerial vehicle may include the UAV of Reference [8].

As shown in FIGS. 2 to 5, a service link may be established between each of the aerial vehicles 220, 320, 420, and 520 and each of the terminals 210, 310, 410, and 510, and the service link may be a radio link. Each of the aerial vehicles 220, 320, 420, and 520 may provide communication services to each of the terminals 210, 310, 410, and 510 by using one or more beams. A footprint of the beam of the aerial vehicles 220, 320, 420, and 520 may have an elliptical shape.

The terminals 210, 310, 410, and 510 may perform communications (e.g., downlink communication, uplink communication) with the aerial vehicles 220, 320, 420, and 520 by using the LTE technology and/or NR technology. The communications between the aerial vehicles 220, 320, 420, and 520 and the terminals 210, 310, 410, and 510 may be performed using NR-Uu interfaces. When dual connectivity (DC) is supported, the terminal 210, 310, 410, or 510 may be connected with not only the aerial vehicle 220, 320, 420, or 520 but also another base station (e.g., base station supporting LTE and/or NR functions), and may perform DC operations based on the technology defined in LTE and/or NR specifications. Meanwhile, the base station 230, 330, 430, or 530 may be connected to the data network 240, 340, 440, or 540. The base stations 230, 330, 430, or 530 and the data networks 140, 240, 340, or 440 may support the NR technology. Communications between the base stations 130, 230, 330, and 430 and the data networks 240, 340, 440, and 540 may be performed based on NG-C/U interfaces. The base stations 230, 330, 430, and 530 may be conventional base stations in terrestrial communication, or satellite base stations.

Meanwhile, entities (e.g., terminals, aerial vehicles, base stations, relay nodes, etc.) constituting the spatial mobile communication networks shown in FIGS. 1 to 5 may be configured as follows.

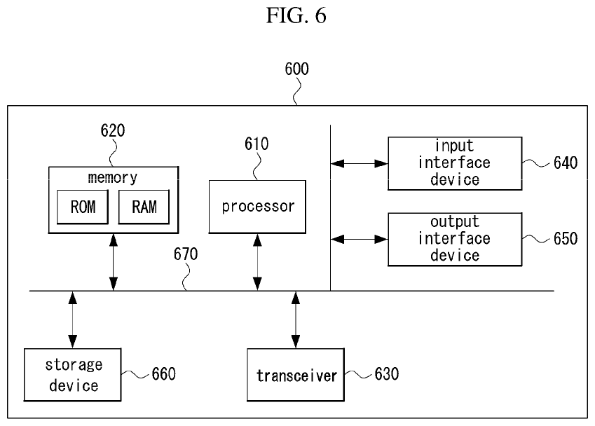

FIG. 6 is a block diagram illustrating a first exemplary embodiment of entities constituting a spatial mobile communication network.

Referring to FIG. 6, an entity 600 may comprise at least one processor 610, a memory 620, and a transceiver 630 connected to a network for performing communications. Also, the entity 600 may further comprise an input interface device 640, an output interface device 650, a storage device 660, and the like. The components included in the entity 600 may communicate with each other as connected through a bus 670.

However, each component included in the entity 600 may not be connected to the common bus 670 but may be connected to the processor 610 via an individual interface or a separate bus. For example, the processor 610 may be connected to at least one of the memory 620, the transceiver 630, the input interface device 640, the output interface device 650 and the storage device 660 via a dedicated interface.

The processor 610 may execute a program stored in at least one of the memory 620 and the storage device 660. The processor 610 may refer to a central processing unit (CPU), a graphics processing unit (GPU), or a dedicated processor on which methods in accordance with embodiments of the present disclosure are performed. Each of the memory 620 and the storage device 660 may be constituted by at least one of a volatile storage medium and a non-volatile storage medium. For example, the memory 620 may comprise at least one of read-only memory (ROM) and random access memory (RAM).

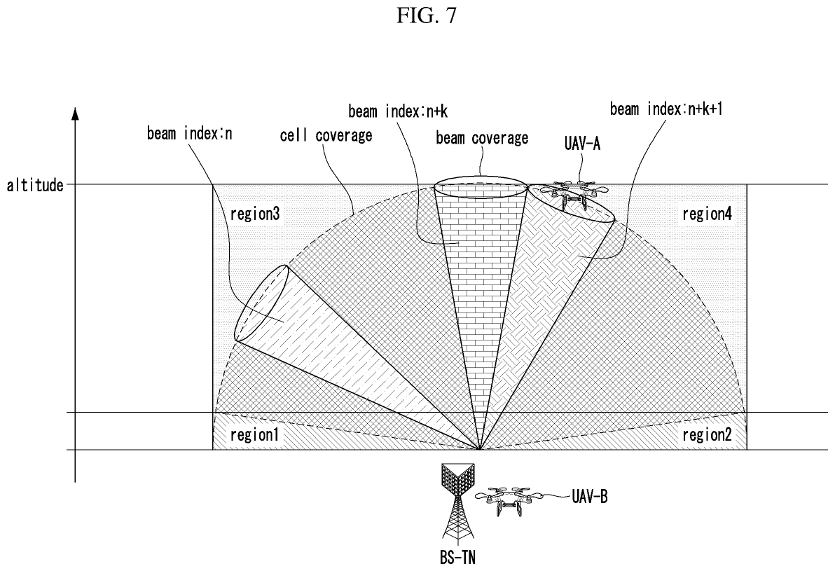

FIG. 7 is a conceptual diagram illustrating a first exemplary embodiment of a cell configuration method in a communication system.

Referring to FIG. 7, in the cell configuration method, a terrestrial base station BS-TN installed on the ground or a first aerial vehicle UAV-B installed at a location not far from the ground may form a cell in a high-altitude air region. That is, the BS-TN or the first aerial vehicle installed at a location not far from the ground may form a cell in a high altitude direction. For example, the first aerial vehicle may be spaced 5 m or less from the ground. The terrestrial base station may be a base station installed on the ground.

In this case, a cell coverage of the cell formed by the terrestrial base station or the first aerial vehicle may have a hemispherical shape. In addition, the terrestrial base station or the first aerial vehicle may form the cell using a single beam or a plurality of beams. Here, the plurality of beams may be projected to different regions. In this case, the plurality of beams may be distinguished from each other using beam indexes. The beam indexes may be expressed as n, n+k, n+k+1, and the like, for example. As such, n and k may be values used to represent the beam indexes, and n and k may be natural numbers. In addition, the plurality of beams may have the same received signal strength at a location at the same distance from the terrestrial base station or the first aerial vehicle. That is, the terrestrial base station or the first aerial vehicle may transmit the beams forming the cell using basically the same power.

Here, a beam coverage (i.e., beam region) of the beam may have an elliptical shape. For example, the first aerial vehicle may provide a communication service to a second aerial vehicle UAV-A using a beam having a beam index n+k+1. Here, the second aerial vehicle may correspond to the aerial vehicle of FIGS. 1 to 5. However, the first aerial vehicle may correspond only to the aerial vehicle of FIGS. 2 to 5.

In the above-described situation, the direction of antennas of the terrestrial base station or the first aerial vehicle may be limited to a front side. Due to such the structural limitation, the terrestrial base station or the first aerial vehicle may not project beams to a region 1 and a region 2 corresponding to side regions. Accordingly, the regions 1 and 2 may be side shadow regions. Accordingly, aerial vehicles located in the region 1 or region 2 may not receive a beam transmitted from the terrestrial base station or the first aerial vehicle. In addition, the terrestrial base station or the first aerial vehicle may not project beams to regions 3 and 4 due to limitations in the maximum transmission power of the antennas. Accordingly, aerial vehicles located in the region 3 or 4 may not receive a beam transmitted from the terrestrial base station or the first aerial vehicle. The region 3 or 4 may be a remote shadow region.

Meanwhile, the terrestrial base station or the first aerial vehicle may configure parameters representatively representing the cell coverage (i.e., cell region) or beam region. In addition, the terrestrial base station or the first aerial vehicle may transmit the configured parameters (i.e., cell configuration information) to the second aerial vehicle. Then, the second aerial vehicle may receive the parameters (i.e., cell configuration information) from the terrestrial base station or the first aerial vehicle. In this case, the terrestrial base station or the first aerial vehicle may transmit not only information of a corresponding serving cell but also information of a neighboring cell to the second aerial vehicle. Accordingly, the second aerial vehicle may estimate the cell coverage or beam coverage of the serving cell based on the received parameters. In addition, the second aerial vehicle may estimate a cell coverage or beam coverage of the neighboring cell based on the received parameters. Accordingly, the second aerial vehicle may facilitate cell or beam coverage change, handover, or beam switching with reference to the received parameters.

### Configuration Parameters of Cell Configuration Information

Center position parameter: The center position parameter may be a parameter indicating a center position of the cell coverage or beam region. For example, the center position parameter may be configured with (x, y, z) coordinates of a point corresponding to the center of the cell coverage or beam region.
Center angle parameter: The center angle parameter may be a parameter indicating the angle of the center of the cell coverage or beam region. For example, the center angle parameter may be a boresight angle formed by a boresight line with respect to an oblique line. As another example, the center angle parameter may be an elevation angle, which is an angle between the horizontal plane and the boresight line.
Radius parameter: The radius parameter may be a parameter indicating a radius of the cell coverage or beam coverage.
Diameter parameter: The diameter parameter may be a parameter indicating a diameter of the cell coverage or beam coverage.
Maximum transmission power parameter: The maximum transmission power parameter may be a parameter indicating the maximum transmission power of the cell or beam.
Maximum altitude parameter: The maximum altitude parameter may be a parameter indicating the maximum altitude at which the cell or beam can serve.

Meanwhile, the terrestrial base station or the first aerial vehicle may configure various cell coverages according to the type of the second aerial vehicle, mobility, existence or non-existence of a specific region according to time, and/or the like. In addition, the terrestrial base station or the first aerial vehicle may move, reduce, or extend the coverage of the cell to adapt to environmental changes caused by movement, etc. of the second aerial vehicle.

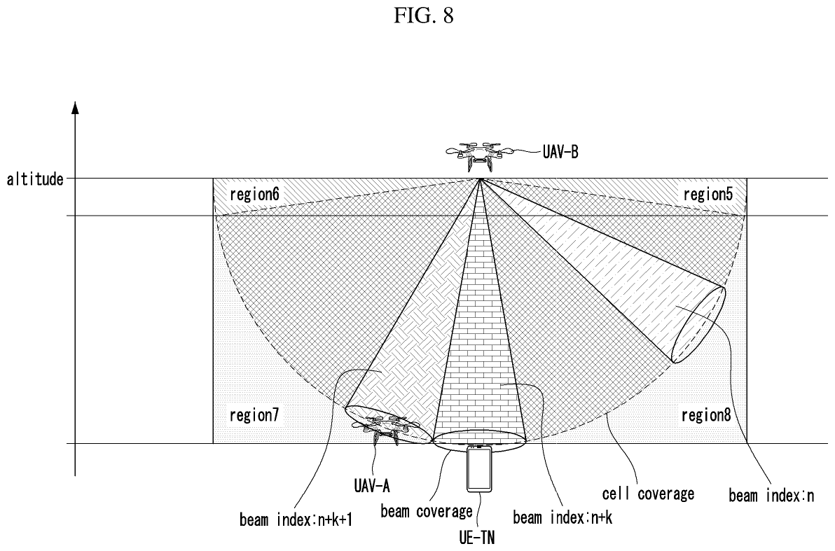

FIG. 8 is a conceptual diagram illustrating a second exemplary embodiment of a cell configuration method in a communication system.

Referring to FIG. 8, in the cell configuration method, the first aerial vehicle UAV-B far from the ground may transmit a plurality of beams toward the ground to form a cell in an air region. That is, the first aerial vehicle may form a cell in a low altitude direction. For example, the first aerial vehicle may be spaced apart from the ground at an altitude of 5 m or more. In this case, the first aerial vehicle may form a cell using a single beam or a plurality of beams. Here, the plurality of beams may be projected to different regions. The plurality of beams may be distinguished from each other using beam indexes. The beam indexes may be expressed as n, n+k, n+k+1, and the like. As such, n and k may be values used to indicate the beam indexes, and n and k may be natural numbers.

In addition, the plurality of beams may have the same received signal strength at a location at the same distance from the first aerial vehicle. That is, the first aerial vehicle may transmit beams forming the cell using basically the same transmission power. Here, the beam coverage of the beam may have an elliptical shape. For example, the first aerial vehicle may provide a communication service to the second aerial vehicle UAV-A using a beam having a beam index n+k+1. Here, the second aerial vehicle may correspond to the aerial vehicle of FIGS. 1 to 5. However, the first aerial vehicle may correspond only to the aerial vehicle of FIGS. 2 to 5. In addition, the first aerial vehicle may provide a communication service to a terrestrial terminal UE-TN using a beam having a beam index n+k. Here, the terrestrial terminal may be a terminal existing on the ground and may be, for example, a car, a train, a smart phone, an Internet of Things device, a ship, or the like.

In this situation, the antennas of the first aerial vehicle may be limited in a direction toward the ground. Due to such the structural limitation, the first aerial vehicle may not project beams to regions 5 and 6. Accordingly, the regions 5 and 6 may be side shadow regions. Accordingly, aerial vehicles located in the region 5 or 6 may not receive a beam transmitted from the first aerial vehicle. In addition, the first aerial vehicle may not project beams to regions 7 and 8 due to limitations in the maximum transmission power of the antennas. Accordingly, aerial vehicles located in the region 7 or 8 may not receive a beam transmitted from the first aerial vehicle. The region 7 or 8 may be a remote shadow region.

Meanwhile, the first aerial vehicle may configure parameters representatively representing the cell coverage or beam region. In this case, the configured parameters may include at least one of a center position parameter, a center angle parameter, a radius parameter, a diameter parameter, a maximum transmission power parameter, a maximum altitude parameter, a minimum altitude parameter, or combinations thereof. Here, the minimum altitude parameter may be a parameter indicating the lowest altitude at which the cell or beam can serve. In addition, the first aerial vehicle may transmit the configured parameters to the second aerial vehicle. Then, the second aerial vehicle may receive the parameters from the first aerial vehicle. In this case, the first aerial vehicle may transmit not only information of a corresponding serving cell but also information of a neighboring cell to the second aerial vehicle. Accordingly, the second aerial vehicle may estimate the cell coverage or beam coverage of the serving cell based on the received parameters. In addition, the second aerial vehicle may estimate a cell coverage or beam coverage of the neighboring cell based on the received parameters. Accordingly, the second aerial vehicle may facilitate cell or beam coverage change, handover, or beam switching with reference to the received parameters.

Meanwhile, the first aerial vehicle may configure various cell coverages according to the type of the second aerial vehicle, mobility, existence or non-existence of a specific region according to time, and/or the like. In addition, the first aerial vehicle may move, reduce, or extend the coverage of the cell in response to environmental changes caused by movement, etc. of the second aerial vehicle.

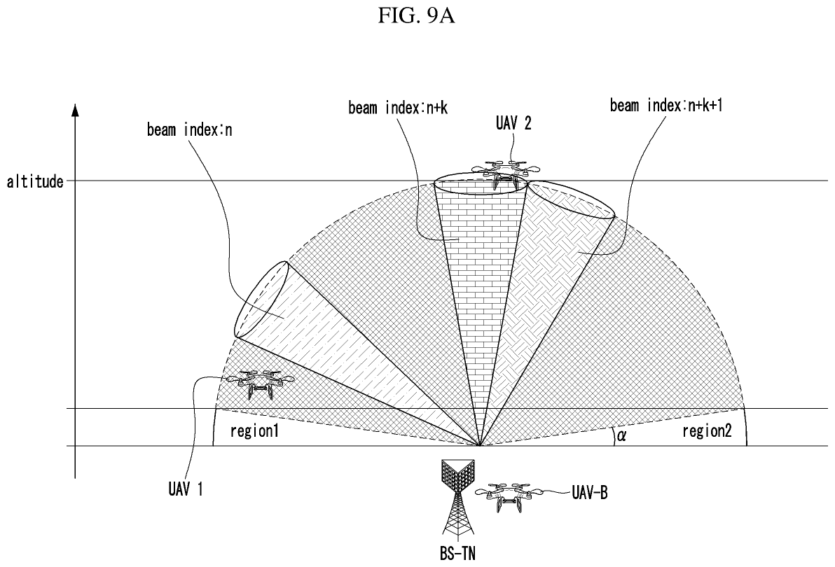

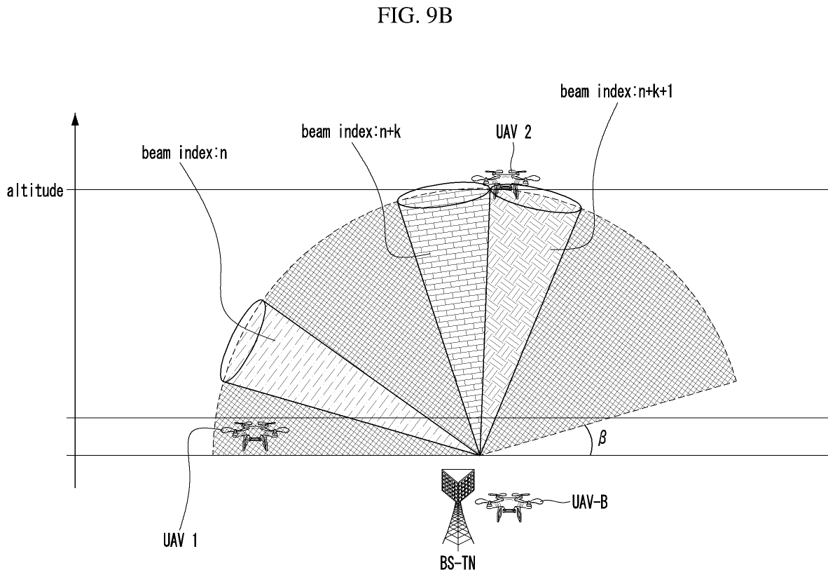

FIGS. 9A and 9B are conceptual diagrams illustrating a third exemplary embodiment of a cell configuration method in a communication system.

Referring to FIG. 9A, in the cell configuration method, a terrestrial base station BS-TN installed on the ground or a first aerial vehicle UAV-B installed at a location not far from the ground may form a cell in a high-altitude air region as shown in FIG. 7. That is, the terrestrial base station BS-TN or the first aerial vehicle installed at a location not far from the ground may form a cell in a high altitude direction. For example, the first aerial vehicle may be spaced 5 m or less from the ground. The terrestrial base station may be a base station installed on the ground.

In this case, a cell coverage of the cell formed by the terrestrial base station or the first aerial vehicle may have a hemispherical shape. In addition, the terrestrial base station or the first aerial vehicle may form the cell using a single beam or a plurality of beams. Here, the plurality of beams may be projected to different regions. In this case, the plurality of beams may be distinguished from each other using beam indexes. The beam indexes may be expressed as n, n+k, n+k+1, and the like, for example. As such, n and k may be values used to represent the beam indexes, and n and k may be natural numbers. In addition, the plurality of beams may have the same received signal strength at a location at the same distance from the terrestrial base station or the first aerial vehicle. That is, the terrestrial base station or the first aerial vehicle may transmit beams forming the cell using basically the same transmission power.

Here, a beam coverage of the beam may have an elliptical shape. For example, the first aerial vehicle may provide a communication service to a second aerial vehicle #1 (i.e., UAV 1) using a beam. In addition, the first aerial vehicle may provide a communication service to a second aerial vehicle #2 (i.e., UAV 2) using a beam having a beam index n+k. Here, the second aerial vehicle #1 and the second aerial vehicle #2 may correspond to the aerial vehicles of FIGS. 1 to 5. However, the first aerial vehicle may correspond only to the aerial vehicle of FIGS. 2 to 5. In this case, the second aerial vehicle #1 and the second aerial vehicle #2 may provide location information to the base station or the first aerial vehicle. Then, the base station or the first aerial vehicle may receive, store, and manage the location information from the second aerial vehicle #1 and the second aerial vehicle #2.

In the above-described situation, the direction of antennas of the terrestrial base station or the first aerial vehicle may be limited to a front side. Due to such the structural limitation, the terrestrial base station or the first aerial vehicle may not project beams to regions 1 and 2 corresponding to side regions. Accordingly, the region 1 may be a first side shadow region, and the region 2 may be a second side shadow region. Accordingly, aerial vehicles located in the region 1 or the region 2 may not receive a beam transmitted from the terrestrial base station or the first aerial vehicle. In addition, the terrestrial base station or the first aerial vehicle may not project beams to regions 3 and 4 due to limitations in the maximum transmission power of the antennas. Accordingly, aerial vehicles located in the region 3 or 4 may not receive a beam transmitted from the terrestrial base station or the first aerial vehicle. The region 3 or 4 may be a remote shadow region.

Meanwhile, the terrestrial base station or the first aerial vehicle may configure parameters representatively representing the cell coverage or beam coverage. In this case, the configured parameters may include at least one of a center position parameter, a center angle parameter, a radius parameter, a diameter parameter, a maximum transmission power parameter, a maximum altitude parameter, or combinations thereof. In addition, the terrestrial base station or the first aerial vehicle may transmit the configured parameters to the second aerial vehicle #1 and the second aerial vehicle #2. Then, the second aerial vehicle #1 and the second aerial vehicle #2 may receive the parameters from the terrestrial base station or the first aerial vehicle. In this case, the terrestrial base station or the first aerial vehicle may transmit not only information of a corresponding serving cell but also information of a neighbor cell to the second aerial vehicle #1 and the second aerial vehicle #2. Accordingly, the second aerial vehicle #1 and the second aerial vehicle #2 may estimate the cell coverage or beam area of the serving cell based on the received parameters. In addition, the second aerial vehicle #1 and the second aerial vehicle #2 may estimate a cell coverage or beam region of the neighboring cell based on the received parameters. As a result, the second aerial vehicle #1 and the second aerial vehicle #2 may facilitate cell or beam coverage change, handover, or beam switching with reference to the received parameters.

Meanwhile, referring to FIG. 9B, in the cell configuration method, the second aerial vehicle #1 may move to the first side shadow region while being connected to the base station or the first aerial vehicle. In this case, the second aerial vehicle #1 may provide information of a movement route and location information of a destination to the base station or the first aerial vehicle. Here, the location information may include at least one of coordinates, altitude, or elevation angle of the location. Then, the base station or the first aerial vehicle may receive the information on the movement route and the location information of the destination from the second aerial vehicle #1.

Accordingly, the base station or the first aerial vehicle may determine whether the location of the destination is within the cell coverage. As a result of the determination, the base station or the first aerial vehicle may maintain the cell coverage in the current state when the location of the destination is within the cell coverage. On the other hand, the base station or the first aerial vehicle may determine whether the destination is located in the first side shadow region closest to the current location of the second aerial vehicle #1 when the location of the destination is out of the cell coverage.

As a result of the determination, the base station or the first aerial vehicle may extend the cell coverage of the cell to the first side shadow region (i.e., region 1) when the destination is located in the first side shadow region, and provide a communication service to the second aerial vehicle #1 that has moved to the first side shadow region. In this case, the terrestrial base station or the first aerial vehicle may extend the shadow region of the second side shadow region (i.e., region 2).

That is, the terrestrial base station or the first aerial vehicle may move the cell coverage of the cell by rotating the cell coverage of the cell around a point where the terrestrial base station or the first aerial vehicle is located. In this case, the terrestrial base station or the first aerial vehicle may move the cell coverage of the cell while maintaining a solid angle of the cell coverage of the cell. Accordingly, the angle that the cell's cell coverage forms with respect to the ground may increase from a to β with respect to the second side shadow region (i.e., region 2). Here, α and β mean angles formed by the cell coverage with respect to the horizontal plane, and β may be greater than α.

Here, the terrestrial base station or the first aerial vehicle may change the cell coverage of the cell by changing a beam direction of the antenna array provided therewith. Alternatively, the first aerial vehicle may change the cell coverage of the cell by changing the beam direction of the antenna array by performing rolling to rotate around the x-axis or pitching to rotate around the y-axis while levitating in the air. Meanwhile, the base station or the first aerial vehicle may determine whether a beam change is required for the connected second aerial vehicle #2. In this case, the base station or the first aerial vehicle may determine whether a beam change is required by reflecting the current location of the second aerial vehicle #2 and the changed angle of the cell coverage. As a result of the determination, the base station or the first aerial vehicle may maintain a beam providing a communication service to the second aerial vehicle #2 when a beam change is not required.

On the other hand, the base station or the first aerial vehicle may change the beam providing a communication service to the second aerial vehicle #2 when a beam change is required. In addition, the base station or the first aerial vehicle may notify the changed beam to the second aerial vehicle #2. Then, the second aerial vehicle #2 may receive information on the changed beam from the base station or the first aerial vehicle. Thereafter, the base station or the first aerial vehicle may provide a communication service to the second aerial vehicle #2 using the changed beam after changing the cell coverage. Then, the second aerial vehicle #2 may receive the beam transmitted from the base station or the first aerial vehicle by referring to the received information on the changed beam.

For example, the base station or the first aerial vehicle may provide a communication service to the second aerial vehicle #2 using a beam currently having a beam index of n+k. In this case, the base station or the first aerial vehicle may maintain the beam having the beam index n+k as the beam providing a communication service to the second aerial vehicle #2 if a beam change is not required. On the other hand, the base station or the first aerial vehicle may change the beam providing a communication service to the second aerial vehicle #2 to a neighboring beam having a beam index of n+k+1 when a beam change is required. Then, the base station or the first aerial vehicle may notify the second aerial vehicle #2 of information on the changed beam. Then, the second aerial vehicle #2 may receive information on the changed beam from the base station or the first aerial vehicle. Thereafter, the base station or the first aerial vehicle may provide a communication service to the second aerial vehicle #2 using the beam having the changed beam index of n+k+1 after changing the cell coverage. Then, the second aerial vehicle #2 may receive the beam transmitted from the base station or the first aerial vehicle by referring to the received information on the changed beam.

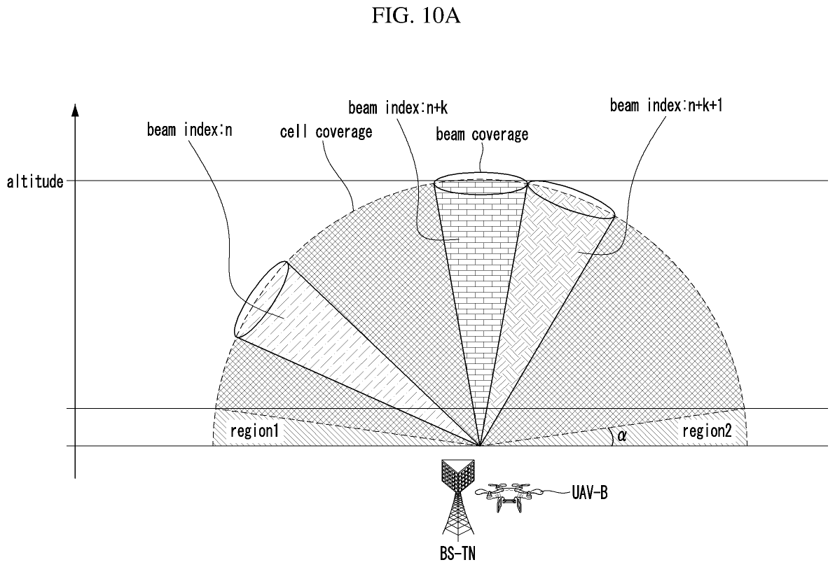

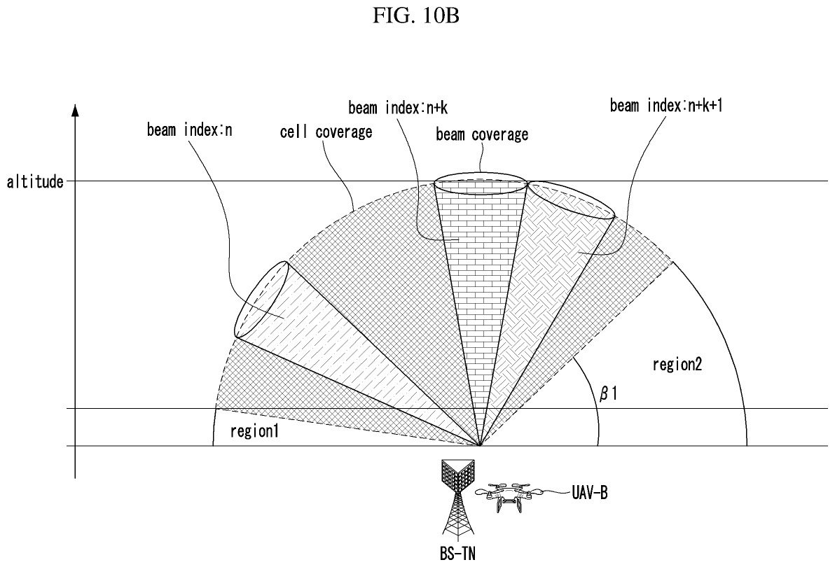

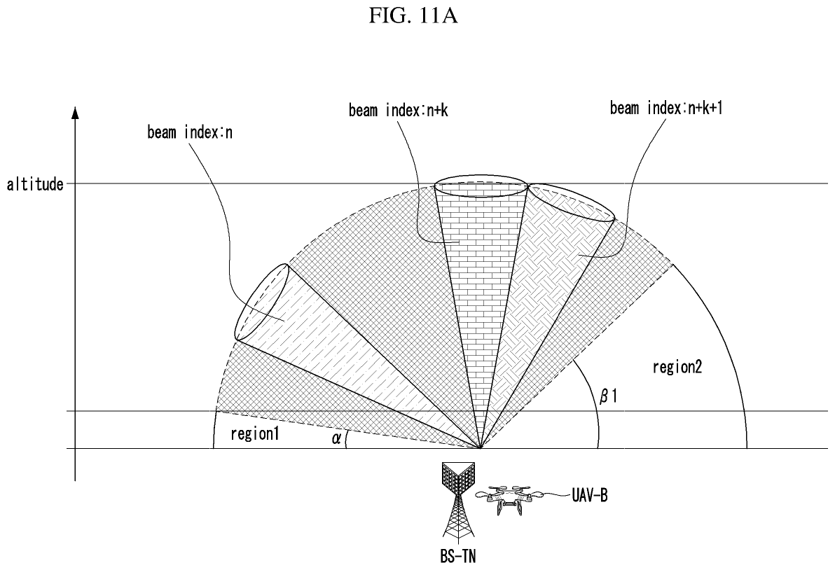

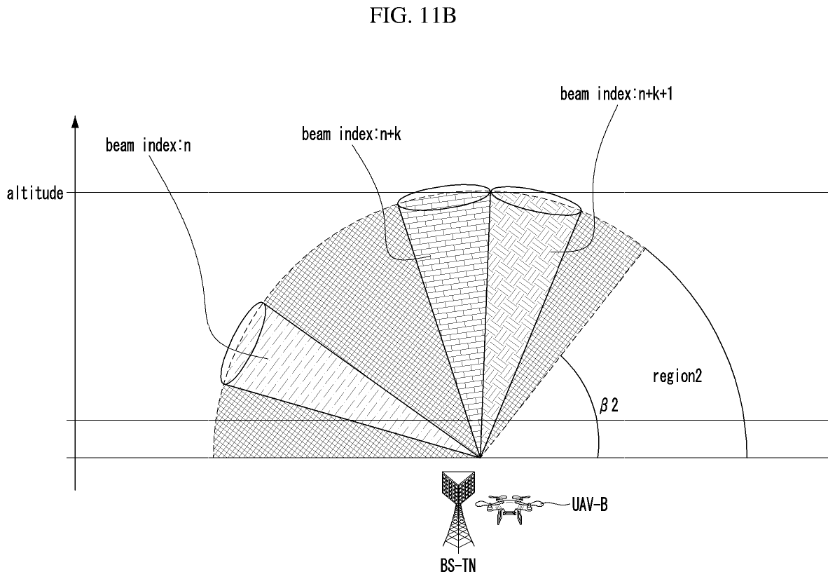

Meanwhile, the terrestrial base station or the first aerial vehicle may configure various cell coverages according to the type of the second aerial vehicle #1 and the second aerial vehicle #2, mobility, existence or non-existence of a specific region according to time, and/or the like. In addition, the terrestrial base station or the first aerial vehicle may move the cell coverage as described above by adapting to environmental changes caused by movement of the second aerial vehicle #1 and the second aerial vehicle #2. In addition, the terrestrial base station or the first aerial vehicle may reduce the cell coverage as shown in FIGS. 10A and 10B by adapting to the environmental change caused by the movement of the second aerial vehicle #1 and the second aerial vehicle #2. In addition, after the terrestrial base station or the first aerial vehicle reduces the coverage of the cell as shown in FIG. 11A, it may move the cell coverage as shown in FIG. 11B.

FIGS. 10A and 10B are conceptual diagrams illustrating a fourth exemplary embodiment of a cell configuration method in a communication system.

Referring to FIG. 10A, in the cell configuration method, a terrestrial base station BS-TN installed on the ground or an aerial vehicle UAV-B installed at a location not far from the ground may form a cell in a high-altitude air region as shown in FIG. 7. That is, the terrestrial base station BS-TN or the aerial vehicle installed at a location not far from the ground may form a cell in a high altitude direction. The aerial vehicle may be separated from the ground by 5 m or less, for example. The terrestrial base station may be a base station installed on the ground.

In this case, a cell coverage of the cell formed by the terrestrial base station or the aerial vehicle may have a hemispherical shape. Also, the terrestrial base station or the aerial vehicle may form the cell using a single beam or a plurality of beams. Here, the plurality of beams may be projected to different regions. In this case, the plurality of beams may be distinguished from each other using beam indexes. The beam indexes may be expressed as n, n+k, n+k+1, and the like, for example. As such, n and k may be values used to represent the beam indexes, and n and k may be natural numbers. In addition, the plurality of beams may have the same received signal strength at a location at the same distance from the terrestrial base station or aerial vehicle. That is, the terrestrial base station or the aerial vehicle may transmit the beams forming the cell using basically the same transmission power.

Here, the beam coverage of the beam may have an elliptical shape. For example, the aerial vehicle may provide a communication service to other aerial vehicles (not shown) flying within the cell coverage using the beam. Here, other aerial vehicles may correspond to the aerial vehicle of FIGS. 1 to 5. However, the aerial vehicles may correspond only to the aerial vehicle of FIGS. 2 to 5. In this case, other aerial vehicles may provide location information to the base station or aerial vehicle. Then, the base station or aerial vehicle may receive, store, and manage the location information from other aerial vehicles.

In the above-described situation, the direction of the antennas of the terrestrial base station or the aerial vehicle may be limited to a front side. Due to such the structural limitation, the terrestrial base station or aerial vehicle may not project beams to regions 1 and 2 corresponding to side regions. Accordingly, the region 1 may be a first side shadow region, and the region 2 may be a second side shadow region.

Meanwhile, referring to FIG. 10B, the terrestrial base station or aerial vehicle may reduce the cell coverage of the cell in order to avoid interference with a neighboring cell. In this case, the terrestrial base station or aerial vehicle may reduce the cell coverage of the cell by reducing a solid angle of the cell coverage of the cell. As a result, the angle that the cell coverage of the cell forms with respect to the ground may increase from α to β1 with respect to the second side shadow region (i.e., region 2). Here, α and β1 mean angles formed by cell the coverage with respect to the horizontal plane, and β1 may be greater than α.

Here, the terrestrial base station or aerial vehicle may reduce the cell coverage of the cell by changing the beam direction of the antenna array provided therewith. Alternatively, the aerial vehicle may reduce the cell coverage of the cell by changing the beam direction of the antenna array by performing rolling to rotate around the x-axis or pitching to rotate around the y-axis while levitating in the air.

FIGS. 11A and 11B are conceptual diagrams illustrating a fifth exemplary embodiment of a cell configuration method in a communication system.

Referring to FIG. 11A, in the cell configuration method, a terrestrial base station BS-TN installed on the ground or an aerial vehicle UAV-B installed at a location not far from the ground may reduce a cell coverage of a cell in order to avoid severe interference when the service interference occurs due to a neighboring cell. In this case, the terrestrial base station or the aerial vehicle may reduce the cell coverage of the cell by reducing a solid angle of the cell coverage of the cell. As a result, the angle that the cell's cell coverage forms with respect to the ground may increase from α to β1 for the region 2. Here, β1 means an angle formed by the cell coverage with respect to the horizontal plane, and β1 may be greater than α. Here, the terrestrial base station or aerial vehicle may reduce the cell coverage of the cell by changing the beam direction of the antenna array provided therewith. Alternatively, the aerial vehicle may reduce the cell coverage of the cell by changing the beam direction of the antenna array by performing rolling to rotate around the x-axis or pitching to rotate around the y-axis while levitating in the air.

Meanwhile, referring to FIG. 11B, in the cell configuration method, the terrestrial base station or aerial vehicle may move the cell coverage to provide a communication service to the region 1. In this case, the terrestrial base station or aerial vehicle may extend the shadow region for the region 2.

That is, the terrestrial base station or aerial vehicle may move the cell coverage of the cell by rotating the cell coverage of the cell to the left around a point where the terrestrial base station or aerial vehicle is located. In this case, the terrestrial base station or aerial vehicle may move the cell coverage of the cell while maintaining the solid angle of the cell coverage of the cell. As a result, the angle that the cell's cell coverage forms with respect to the ground may increase from 1 to β2 with respect to the region 2. Here, β1 and β2 mean angles formed by cell coverage with respect to the horizontal plane, and β2 may be greater than β1.

Here, the terrestrial base station or aerial vehicle may change the cell coverage of the cell by changing the beam direction of the antenna array. Alternatively, the aerial vehicle may change the cell coverage of the cell by changing the beam direction of the antenna array by performing rolling to rotate around the x-axis or pitching to rotate around the y-axis while levitating in the air.

Meanwhile, in FIGS. 9A to 11B, the terrestrial base station BS-TN or aerial vehicle UAV-B may adjust the cell coverage in consideration of at least one of the locations, number, and movement routes of aerial vehicles being served, a transmission/reception delay according to resource allocation, received signal strength, or interference caused by neighboring cells.

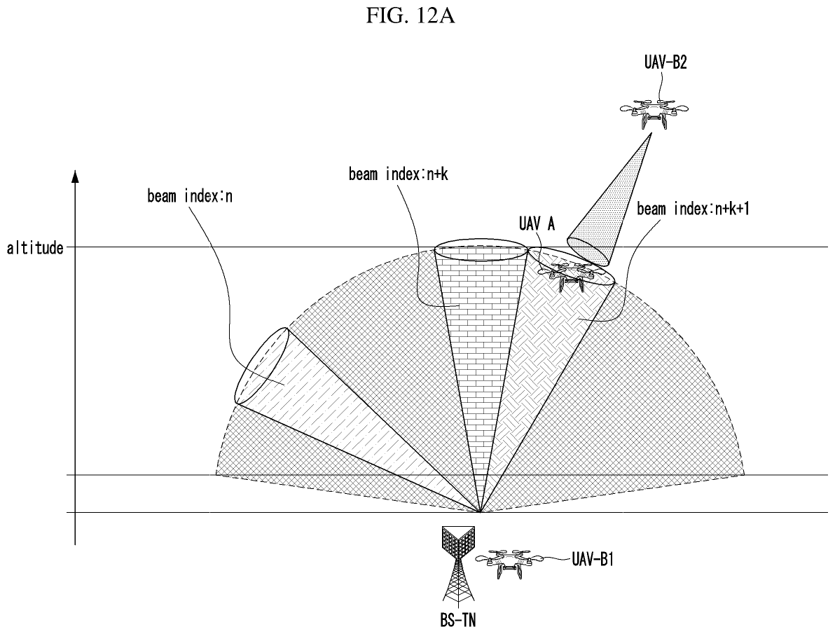

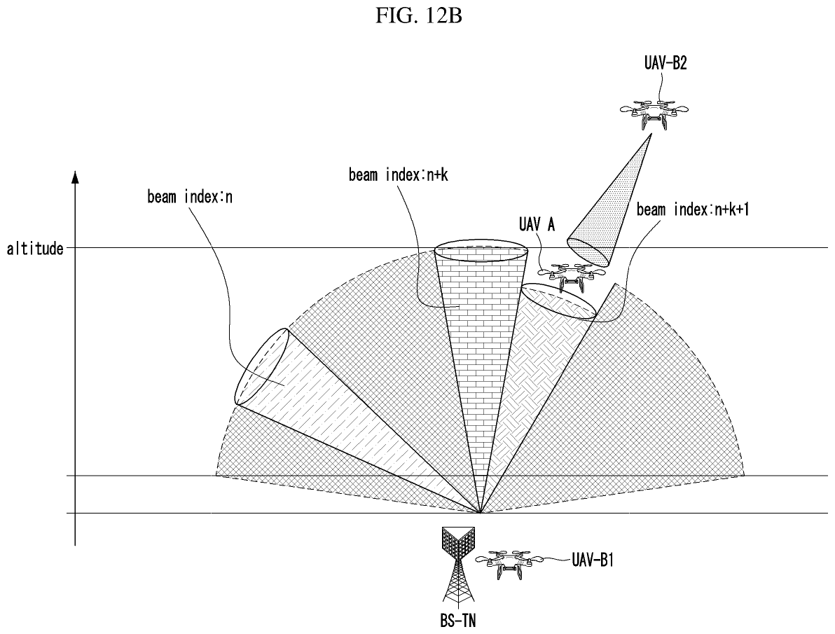

FIGS. 12A and 12B are conceptual diagrams illustrating a sixth exemplary embodiment of a cell configuration method in a communication system.

Referring to FIG. 12A, in the cell configuration method, a first aerial vehicle (i.e., UAV-B1) installed at a location not far from the ground may form a cell in a high-altitude air region as shown in FIG. 7. That is, the first aerial vehicle #1 may form a cell in a high altitude direction. In this case, the first aerial vehicle #2 (i.e., UAV-B2) spaced a long distance from the ground may form a cell in an air region at a low altitude as shown in FIG. 8. That is, the first aerial vehicle #2 may form the cell in a low altitude direction.

The first aerial vehicle #1 or the first aerial vehicle #2 may configure parameters representatively representing the cell coverage or beam coverage. In this case, the configured parameters may include at least one of a center position parameter, a center angle parameter, a radius parameter, a diameter parameter, a maximum transmission power parameter, a maximum altitude parameter, a minimum altitude parameter, or combinations thereof. In addition, the first aerial vehicle #1 or the first aerial vehicle #2 may transmit the parameters representatively representing the cell coverage or beam coverage to the second aerial vehicle UAV-A.

In this case, the first aerial vehicle #1 may receive parameters from the first aerial vehicle #2 and transfer them to the second aerial vehicle. Similarly, the first aerial vehicle #2 may receive parameters from the first aerial vehicle #1 and transfer them to the second aerial vehicle. Accordingly, the second aerial vehicle may estimate the cell coverage or beam coverage of the first aerial vehicle #1 based on the received parameters. In addition, the second aerial vehicle may estimate the cell coverage or beam coverage of the first aerial vehicle #2 based on the received parameters. As a result, the second aerial vehicle may identify a nearby aerial vehicle among the first aerial vehicle #1 and the first aerial vehicle #2 with reference to the received parameters. As a result of the identification, if the first aerial vehicle #2 is closer than the first aerial vehicle #1, the second aerial vehicle may be connected to the first aerial vehicle #2 that is adjacent to the second aerial vehicle.

Meanwhile, the second aerial vehicle may receive severe interference from a signal transmitted from the first aerial vehicle #1 while being connected to the first aerial vehicle #2. Then, the second aerial vehicle may determine a degree of interference received from the first aerial vehicle #1. The second aerial vehicle may request cell reduction from the first aerial vehicle #1 when the detected degree of interference (e.g., received signal strength) exceeds a threshold.

In this case, the second aerial vehicle may transmit, to the first aerial vehicle #1, at least one of received signal strength indicator (RSSI) information, reference signal received power (RSRP) information, reference signal received quality (RSRQ) information, signal to interference-plus-noise ratio (SINR) information, signal-to-noise ratio (SNR) information, or combinations thereof measured for the first aerial vehicle #1. In this case, the second aerial vehicle may transfer the configuration parameters received from the first aerial vehicle #2 to the first aerial vehicle #1. In addition, the second aerial vehicle may transfer at least one of the RSSI information, RSRP information, RSRQ information, SINR information, or SNR information measured for the first aerial vehicle #2 to the first aerial vehicle #1.

In addition, the second aerial vehicle may provide at least one or more of movement route information, current location information, destination location information, or terminal type information to the first aerial vehicle #1. Here, the location information may include at least one of coordinates, altitude, or elevation angle for the location. In addition, the terminal type information may indicate at least one of a leisure aerial vehicle, an aerial vehicle for a base station, an aircraft, or a UAM. In addition, the second aerial vehicle may determine beam indexes of beams having a degree of interference (e.g., received signal strength) equal to or greater than a threshold among a plurality of beams transmitted by the first aerial vehicle #1, and notify the determined beam indexes to the first aerial vehicle #1.

Meanwhile, the first aerial vehicle #1 may receive a cell reduction request from the second aerial vehicle. In addition, the first aerial vehicle #1 may receive at least one of RSSI information, RSRP information, RSRQ information, SINR information, or SNR information measured for the first aerial vehicle #1 from the second aerial vehicle. Also, the first aerial vehicle #1 may receive configuration parameters of the first aerial vehicle #1 from the second aerial vehicle.

In addition, the first aerial vehicle #1 may receive at least one of RSSI information, RSRP information, RSRQ information, SINR information, or SNR information measured for the first aerial vehicle #2 from the second aerial vehicle. In addition, the first aerial vehicle #1 may receive at least one of movement route information, current location information, destination location information, and terminal type information from the second aerial vehicle. In addition, the first aerial vehicle #1 may receive beam index information of beams having a degree of interference (e.g., received signal strength) greater than or equal to a threshold among a plurality of beams. Accordingly, the first aerial vehicle #1 may identify beam indexes of beams interfering with a beam providing a communication service from the first aerial vehicle #2 to the second aerial vehicle.

In addition, as can be seen in FIG. 12B, the first aerial vehicle #1 may reduce the beam coverage by reducing the transmission power of beams that cause interference. That is, the first aerial vehicle #1 may reduce the transmission power of interfering beams to reduce the cell. As a result, the second aerial vehicle may receive the communication service from the first aerial vehicle #2 without severe interference from the first aerial vehicle #1. Of course, the first aerial vehicle #1 may reduce the cell coverage by reducing the transmission power of all beams to reduce reach distances of all the beams. Also, the first aerial vehicle #1 may reduce the cell by not transmitting a beam causing interference.

Here, the first aerial vehicle #1 reduces the cell when receiving a cell reduction request from the second aerial vehicle, but may also reduce the cell without such the request. That is, the first aerial vehicle #1 may reduce the cell by adjusting the transmission power of beams based on the configuration parameters of the first aerial vehicle #2 received from the second aerial vehicle. In this case, the first aerial vehicle #1 may estimate the cell coverage or beam coverage of the first aerial vehicle #2 based on the received parameters. As a result, the first aerial vehicle #1 may identify beam indexes of beams interfering with the beam providing a communication service from the first aerial vehicle #2 to the second aerial vehicle with reference to the received parameters. In addition, as can be seen in FIG. 12B, the first aerial vehicle #1 may reduce the beam coverage by reducing the transmission power of beams that cause interference.

The second aerial vehicle may identify a nearby aerial vehicle from among the first aerial vehicle #1 and the first aerial vehicle #2 with reference to the received parameters. As a result of the identification, if the first aerial vehicle #2 is closer than the first aerial vehicle #1, the second aerial vehicle may be connected to the first aerial vehicle #2 that is adjacent to the second aerial vehicle.

Meanwhile, the first aerial vehicle may receive severe interference from a signal transmitted from the second aerial vehicle #1 while being connected to the second aerial vehicle #2. Then, the first aerial vehicle may determine a degree of interference received from the second aerial vehicle #1. The first aerial vehicle may request cell reduction from the second aerial vehicle #1 when the determined degree of interference is greater than or equal to a threshold.

In this case, the first aerial vehicle may transmit, to the second aerial vehicle #1, at least one of RSSI information, RSRP information, RSRQ information, SINR information, or SNR information measured for the second aerial vehicle #1. In addition, the first aerial vehicle may transmit the configuration parameters received from the second aerial vehicle #2 to the second aerial vehicle #1. In addition, the first aerial vehicle may transmit, to the second aerial vehicle #1, at least one of RSSI information, RSRP information, RSRQ information, SINR information, or SNR information measured for the second aerial vehicle #2. In addition, the first aerial vehicle may provide at least one or more of movement route information, current location information, destination location information, or terminal type information to the second aerial vehicle #1. Here, the location information may include at least one of coordinates, altitude, or elevation angle for the location. In addition, the terminal type may indicate at least one of a leisure aerial vehicle, an aerial vehicle for a base station, an aircraft, a UAM, or the like. In addition, the second aerial vehicle may determine beam indexes of beams having a degree of interference greater than or equal to a threshold among a plurality of beams transmitted by the first aerial vehicle #1, and inform the first aerial vehicle #1 of the beam indexes.

Meanwhile, the first aerial vehicle #1 may receive a cell reduction request from the second aerial vehicle. In addition, the first aerial vehicle #1 may receive at least one of RSSI information, RSRP information, RSRQ information, SINR information, or SNR information measured for the first aerial vehicle #1 from the second aerial vehicle. In addition, the first aerial vehicle #1 may receive configuration parameters of the first aerial vehicle #2 from the second aerial vehicle. In addition, the first aerial vehicle #1 may receive at least one of RSSI information, RSRP information, RSRQ information, SINR information, or SNR information measured for the first aerial vehicle #2 from the second aerial vehicle. In addition, the first aerial vehicle #1 may receive at least one of movement route information, current location information, destination location information, and terminal type information from the second aerial vehicle. In addition, the first aerial vehicle #1 may receive beam index information of beams having a degree of interference equal to or greater than a threshold among a plurality of beams. Accordingly, the first aerial vehicle #1 may identify beam indexes of beams interfering with a beam providing a communication service from the first aerial vehicle #2 to the second aerial vehicle.

In addition, as can be seen in FIG. 12B, the first aerial vehicle #1 may reduce the beam coverage by reducing the transmission power of beams causing interference (e.g., beam index n+k+1). That is, the first aerial vehicle #1 may reduce the transmission power of interfering beams to reduce the cell. As a result, the second aerial vehicle may receive the communication service from the first aerial vehicle #2 without severe interference from the first aerial vehicle #1.

Here, the first aerial vehicle #1 reduces the cell when receiving a cell reduction request from the second aerial vehicle, but may reduce the cell without such the request. That is, the first aerial vehicle #1 may receive at least one of RSSI information, RSRP information, RSRQ information, SINR information, or SNR information measured for the first aerial vehicle #1 from the second aerial vehicle. In addition, the first aerial vehicle #1 may receive configuration parameters of the second aerial vehicle #2 from the second aerial vehicle. In addition, the first aerial vehicle #1 may receive at least one of RSSI information, RSRP information, RSRQ information, SINR information, or SNR information measured for the first aerial vehicle #2 from the second aerial vehicle. In addition, the first aerial vehicle #1 may receive at least one of movement route information, current location information, destination location information, and terminal type information from the second aerial vehicle. In addition, the first aerial vehicle #1 may receive beam index information of beams having a degree of interference equal to or greater than a threshold among a plurality of beams. Accordingly, the first aerial vehicle #1 may identify beam indexes of beams interfering with a beam providing a communication service from the first aerial vehicle #2 to the second aerial vehicle. Here, the first aerial vehicle #1 receives and identifies beam indexes of interfering beams from the second aerial vehicle, but otherwise, they may be estimated based on information received from the second aerial vehicle.

In addition, as can be seen in FIG. 12B, the first aerial vehicle #1 may reduce the beam coverage by reducing the transmission power of beams causing interference (e.g., the beam index n+k+1). That is, the first aerial vehicle #1 may reduce the transmission power of interfering beams to reduce the cell. As a result, the second aerial vehicle may receive the communication service from the first aerial vehicle #2 without severe interference from the first aerial vehicle #1.

Meanwhile, although the first aerial vehicle #1 reduces the cell coverage by reducing the beam coverage, the first aerial vehicle #2 may reduce the cell coverage by reducing the beam coverage. In this case, the operation performed by the first aerial vehicle #2 may be similar to the operation performed by the first aerial vehicle #1. Contrary to the description above, the first aerial vehicle #1 may extend the cell coverage by extending the beam coverage as needed. The process of extending the cell coverage may be similar to the cell coverage reduction described above, and thus a detailed description thereof will be omitted.

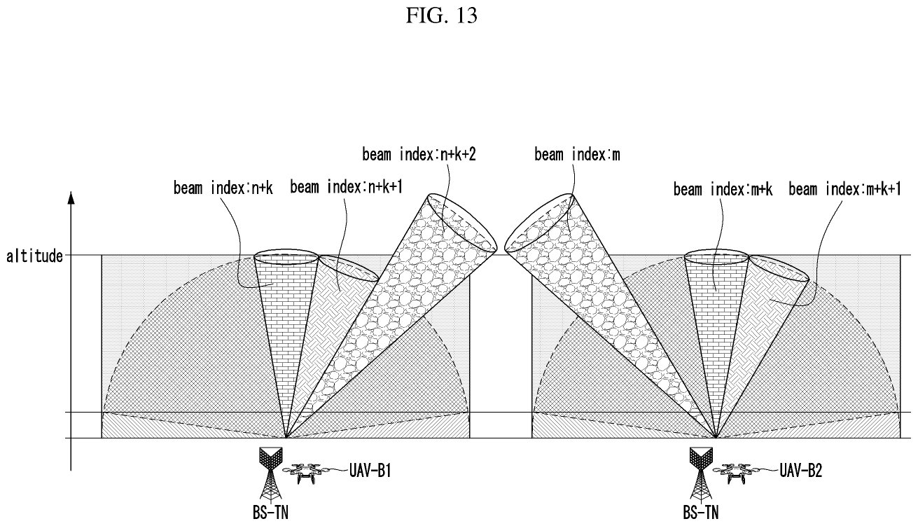

FIG. 13 is a conceptual diagram illustrating a seventh exemplary embodiment of a cell configuration method in a communication system.

Referring to FIG. 13, in the cell configuration method, each of a first aerial vehicle #1 (i.e., UAV-B1) and a first aerial vehicle #2 (i.e., UAV-B2) may configure a transmission power differently for each beam to configure a cell coverage. Referring to FIG. 7, when the aerial vehicle UAV-B configures a cell coverage with beams having the same transmission power, there may be regions (i.e., regions 3 and 4) not covered by the cell. Accordingly, referring again to FIG. 13, the first aerial vehicle #1 and the first aerial vehicle #2 may configure the cell coverage by setting the transmission power differently for each beam. To this end, the first aerial vehicle #1 may set a transmission power of a beam having a beam index of n+k+2 to be higher than those of other beams in order to include the region 4 in the cell coverage. In addition, the first aerial vehicle #2 may set a transmission power of a beam having a beam index of m to be higher than those of other beams in order to include the region 3 in the cell coverage. Here, n, k, and m may be natural numbers.

Meanwhile, the first aerial vehicle #1 may form a group beam with beams having the same transmission power. For example, the first aerial vehicle #1 may configure a beam having a beam index n+k and a beam having a beam index n+k+1, which have the same transmission power, as a group beam 1. In addition, the first aerial vehicle #1 may configure a beam having a beam index n+k+2, which has a different transmission power than the beams of the group beam 1, as a group beam 2. Also, the first aerial vehicle #2 may form a group with beams having the same transmission power. For example, the first aerial vehicle #2 may configure a beam having a beam index m+k and a beam having a beam index m+k+1, which have the same transmission power, as a group beam 1. In addition, the first aerial vehicle #2 may configure a beam having a beam index m, which has a different transmission power than the beams of the group beam 1, as a group beam 2.

Then, the first aerial vehicle #1 and the first aerial vehicle #2 may allocate a bandwidth part (BWP) for each group beam. In this case, the first aerial vehicle #1 and the first aerial vehicle #2 may allocate different BWPs for the respective group beams. Also, the first aerial vehicle #1 and the first aerial vehicle #2 may allocate a polarization for each group beam. In this case, the first aerial vehicle #1 and the first aerial vehicle #2 may allocate different polarizations to the respective group beams. In addition, the first aerial vehicle #1 and the first aerial vehicle #2 may allocate a panel (e.g., a transmission and reception point (TRP)) for each group beam. In this case, the first aerial vehicle #1 and the first aerial vehicle #2 may allocate different panels to the respective group beams. In this case, cell coverages as many as the number of group beams may be configured. Also, multiple group beams may be configured for the same coverage.

The first aerial vehicle #1 or the first aerial vehicle #2 may notify the aerial vehicles providing communication services of information on the group beams. In this case, the information on the group beams may include at least one of beam index information, transmission power information, BWP information, polarization information, and panel information of beams included in the group beam.

Meanwhile, the aerial vehicle receiving the communication service may receive the information on the group beams from the first aerial vehicle #1 or the first aerial vehicle #2. In addition, the aerial vehicle receiving the communication service may recognize at least one of beam index information, transmission power information, BWP information, polarization information, and panel information of beams included in each group beam from the information on the group beams. As such, the aerial vehicle receiving the communication service may recognize a plurality of cell coverages as many as the number of group beams.

Meanwhile, the first aerial vehicle #1 and the first aerial vehicle #2 may be disposed adjacent to each other. In this case, for example, the cell coverage configured based on the beam index n+k for the first aerial vehicle #1 and the cell coverage configured based on the beam index m+k for the first aerial vehicle #2 may adjacent to each other. As a result, since an overlapping region between the beam with the beam index n+k+2 and the beam with the beam index m increases, they may interfere with each other. To mitigate this, different frequency regions (e.g., different BWP configurations) may be used for group beams overlapping between cells. Alternatively, different polarizations (e.g., right-hand circularly polarization (RHCP), left-hand circularly polarization (LHCP), etc.) may be used for group beams overlapping between cells. Alternatively, different panels may be used for group beams overlapping between cells.

When the above methods are applied, various coverages may exist for one cell according to time. In addition, various coverages may exist according to neighboring cells of various types (e.g., cell or beam coverage according to the type of aerial vehicle, service type, altitude, and direction). The first aerial vehicle #1 and the first aerial vehicle #2 may reconfigure an optimized cell coverage by combining the above methods through mutual information exchange. Alternatively, the first aerial vehicle #1 and the first aerial vehicle #2 may reconfigure the optimized cell coverage by combining the above methods through information exchange using other connected aerial vehicles.

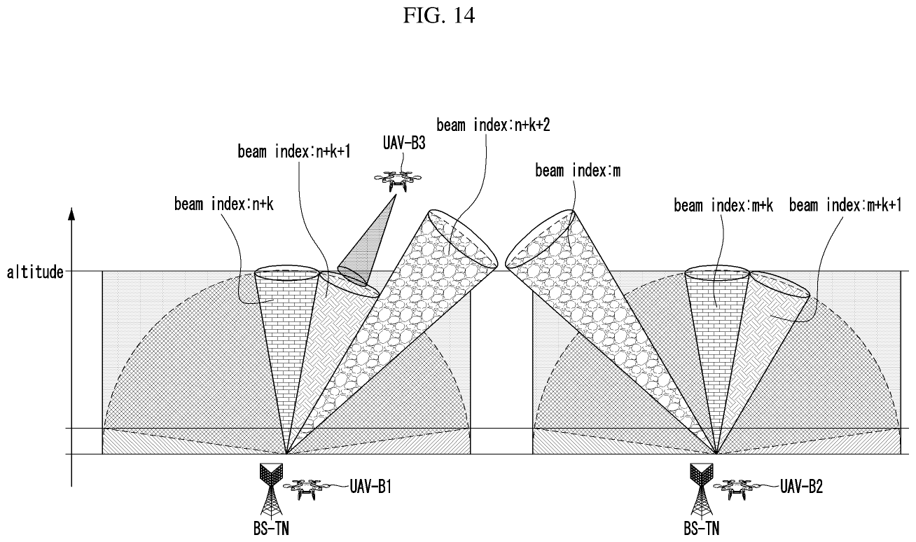

FIG. 14 is a conceptual diagram illustrating an eighth exemplary embodiment of a cell configuration method in a communication system.

Referring to FIG. 14, in the cell configuration method, a first aerial vehicle #1 (i.e., UAV-B1) may form two group beams. Here, the first group beam formed by the first aerial vehicle #1 may include a beam having a beam index n+k and a beam having a beam index n+k+1. Also, the second group beam formed by the first aerial vehicle #1 may include a beam having a beam index n+k+2. Meanwhile, a first aerial vehicle #2 (i.e., UAV-B2) may form two group beams. Here, the first group beam formed by the first aerial vehicle #2 may include a beam having a beam index m+k and a beam having a beam index m+k+1. Also, the second group beam formed by the first aerial vehicle #2 may include a beam having a beam index m. Further, a first aerial vehicle #3 (i.e., UAV-B3) may form a cell coverage with one beam.

In this case, the first group beam formed by the first aerial vehicle may #1 use a first BWP, and the second group beam formed by the first aerial vehicle #1 may use a second BWP. Similarly, the first group beam formed by the first aerial vehicle #2 may use a third BWP, and the second group beam formed by the first aerial vehicle #2 may use a fourth BWP. In addition, the beam formed by the first aerial vehicle #3 may use a fifth BWP.

In this situation, if the second BWP and the fourth BWP are the same, the second group beam formed by the first aerial vehicle #1 and the second group beam formed by the first aerial vehicle #2 may interfere severely. As a result, the first aerial vehicle #1 and the first aerial vehicle #2 may need to adjust the BWPs used with each other. In addition, when the first aerial vehicle #3 uses a specific BWP, interference with the beam having the beam index n+k+1 of the first group beam of the first aerial vehicle #1 may be large. Accordingly, the first aerial vehicle #1 and the first aerial vehicle #3 may need to adjust BWPs used with each other. Therefore, in order to reduce the influence of interference between neighboring cells and between group beams, the first aerial vehicle #1 to the first aerial vehicle #3 may exchange base station information. In this case, the base station information may include at least one cell transmission power information, beam transmission power information, cell BWP information, beam BWP information, beam index information of group beam, group beam BWP information, cell MIMO information, beam MIMO information, cell multiple TRP information, beam multiple TRP information, cell polarization information, beam polarization information, base station type information, cell holding time information, beam holding time information, end time information of a cell, end time information of a beam, region altitude information of a cell, region altitude information of a beam, or combinations thereof.

Here, the base station type may include at least one of service type information, information on whether or not there is a transmission power saving function, information whether or not there is a BWP switching function, or combinations thereof. The service type may be, for example, a communication service in a hot zone region, a communication service for movement of a UAM and an aircraft, and the like. The first aerial vehicles #1 to 3 may cooperate with each other to set priorities according to the base station information to determine which cell changes which parameters. Alternatively, the first aerial vehicles #1 to #3 may exchange priority information with each other so that an aerial vehicle with the highest priority may determine which cell uses which parameters. Here, an aerial vehicle having a higher power level or an aerial vehicle having a larger number of antennas may have a higher priority. Alternatively, the base station information may be collected by a core network to determine which cell uses which parameters. Alternatively, each of the first aerial vehicles #1 to #3 may determine which parameters to change according to the base station information.

Meanwhile, the base station information described above may be exchanged between the first aerial vehicles #1 to #3. Alternatively, the base station information may be exchanged between the first aerial vehicles #1 to #3 through the core network. Alternatively, the base station information may be exchanged through other aerial vehicles connected between the first aerial vehicles #1 to #3.

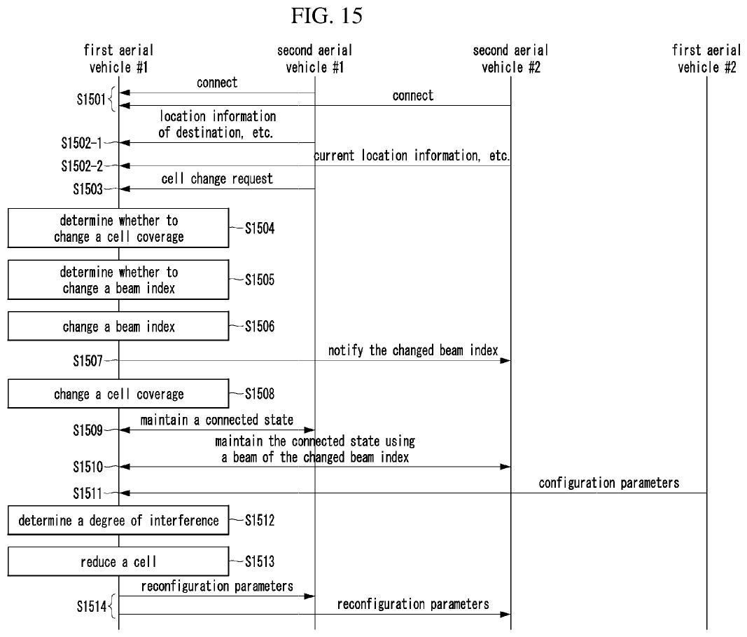

FIG. 15 is a sequence chart illustrating a first exemplary embodiment of a cell coverage configuration method in a communication system.

Referring to FIG. 15, in the cell coverage configuration method, the first aerial vehicle #1 installed at a location that is not separated from the ground by a predetermined distance may form a cell in a high-altitude air region as shown in FIG. 7. In this case, the first aerial vehicle #2 may also form a cell in a high altitude air region adjacent to the first aerial vehicle #1 as shown in FIG. 7. The first aerial vehicle #1 or the first aerial vehicle #2 may configure parameters representatively representing a cell coverage or beam coverage. In this case, the configured parameters may include at least one of a center position parameter, a center angle parameter, a radius parameter, a diameter parameter, a maximum transmission power parameter, a maximum altitude parameter, or combinations thereof. In addition, the first aerial vehicle #1 or the first aerial vehicle #2 may transfer the parameters representatively representing the cell coverage or beam coverage to the second aerial vehicle #1 or the second aerial vehicle #2. In this case, the first aerial vehicle #1 may receive the parameters from the first aerial vehicle #2, and transfer the parameters to the second aerial vehicle #1 or the second aerial vehicle #2. Similarly, the first aerial vehicle #2 may receive the parameters from the first aerial vehicle #1, and transfer the parameters to the second aerial vehicle #1 or the second aerial vehicle #2.

Accordingly, the second aerial vehicle #1 and the second aerial vehicle #2 may estimate the cell coverage or beam coverage of the first aerial vehicle #1 based on the received parameters. In addition, the second aerial vehicle #1 and the second aerial vehicle #2 may estimate the cell coverage or beam coverage of the first aerial vehicle #2 based on the received parameters. As a result, the second aerial vehicle #1 and the second aerial vehicle #2 may identify a nearby aerial vehicle among the first aerial vehicle #1 and the first aerial vehicle #2 with reference to the received parameters. As a result of the identification, the second aerial vehicle #1 and the second aerial vehicle #2 may connect to the adjacent first aerial vehicle #1 when the first aerial vehicle #1 is closer than the first aerial vehicle #2 (S1501).

Meanwhile, the second aerial vehicle #1 may move to a side shadow region while being connected to the first aerial vehicle #1. In this case, the second aerial vehicle #1 may provide the first aerial vehicle #1 with at least one of RSSI information, RSRP information, RSRQ information, SINR information, or SNR information measured for the first aerial vehicle #1. In addition, the second aerial vehicle #1 may provide the first aerial vehicle #1 with at least one of RSSI information, RSRP information, RSRQ information, SINR information, or SNR information measured for the first aerial vehicle #2. In addition, the second aerial vehicle #1 may provide the first aerial vehicle #1 with at least one of movement route information, current location information, destination location information, terminal type information, or combinations thereof (S1502-1). Here, the location information may include at least one of coordinates, altitude, or elevation angle for the location. In addition, the terminal type information may indicate at least one of a leisure aerial vehicle, an aerial vehicle for a base station, an aircraft, or a UAM. Such the terminal type information may be a criterion for determining a priority when the first aerial vehicle #1 provides a service.

Meanwhile, the first aerial vehicle #1 may receive at least one of RSSI information, RSRP information, RSRQ information, SINR information, or SNR information measured for the first aerial vehicle #1 from the second aerial vehicle #1. In addition, the first aerial vehicle #1 may receive at least one of RSSI information, RSRP information, RSRQ information, SINR information, or SNR information measured for the first aerial vehicle #2 from the second aerial vehicle #1. In addition, the first aerial vehicle #1 may receive at least one of movement route information, current location information, destination location information, terminal type information, or combinations thereof from the second aerial vehicle #1.

Alternatively, the second aerial vehicle may be stationary while being connected to the first aerial vehicle #1. In this case, the second aerial vehicle #2 may provide the first aerial vehicle #1 with at least one of RSSI information, RSRP information, RSRQ information, SINR information, or SNR information measured for the first aerial vehicle #1. In addition, the second aerial vehicle #2 may provide the first aerial vehicle #1 with at least one of RSSI information, RSRP information, RSRQ information, SINR information, or SNR information measured for the first aerial vehicle #2. In addition, the second aerial vehicle #2 may provide at least one of current location information and terminal type information to the first aerial vehicle #1 (S1502-2).

Meanwhile, the first aerial vehicle #1 may receive at least one of RSSI information, RSRP information, RSRQ information, SINR information, or SNR information measured for the first aerial vehicle #1 from the second aerial vehicle #2. In addition, the first aerial vehicle #1 may receive at least one of RSSI information, RSRP information, RSRQ information, SINR information, or SNR information measured for the first aerial vehicle #2 from the second aerial vehicle #2. Also, the first aerial vehicle #1 may receive at least one of current location information and terminal type information from the second aerial vehicle #2.

Meanwhile, the second aerial vehicle #1 may identify coverages of a serving cell and a neighboring cell based on the parameters received from the first aerial vehicle #1 or the first aerial vehicle #2. Also, the second aerial vehicle #1 may determine whether a serving cell or a neighboring cell exists in a movement route or a destination based on the identified coverages of the serving cell and the neighboring cell. As a result of the determination, the second aerial vehicle #1 may request a cell coverage change from the first aerial vehicle #1 when there is no serving cell or neighbor cell on the movement route or at the destination (S1503). In addition, the second aerial vehicle #1 may request a cell coverage change from the first aerial vehicle #1 when a radio link failure (RLF) is expected to occur on the movement route or at the destination. Accordingly, the first aerial vehicle #1 may receive a cell coverage change request from the second aerial vehicle #1. Here, although the second aerial vehicle #1 transmits the cell coverage change request after transmitting the RSSI information and the like to the first aerial vehicle #1, the RSSI information and the like may be transmitted along with the cell coverage change request to the first aerial vehicle #1. In addition, although the second aerial vehicle #1 transmits the RSSI information to the first aerial vehicle #1 before requesting the cell coverage change, the second aerial vehicle #1 may transmit the RSSI information and the like to the first aerial vehicle #1 after requesting the cell coverage change.

Accordingly, the first aerial vehicle #1 may determine whether to change the cell coverage based on the movement route information, location information of the destination, and the like received from the second aerial vehicle #1 (S1504). As a result of the determination, the first aerial vehicle #1 may change the cell coverage if the cell coverage needs to be changed (S1508). In addition, the first aerial vehicle #1 may maintain a connected state with the second aerial vehicle #1 using the changed cell coverage (S1509). Looking at this in further detail, the first aerial vehicle #1 may determine whether the movement route or the destination received from the second aerial vehicle #1 is within the cell coverage. As a result of the determination, the first aerial vehicle #1 may maintain the cell coverage in the current state if the movement route or the location of the destination is within the cell coverage. On the other hand, the first aerial vehicle #1 may determine whether the destination is located in the first side shadow region closest to the current location of the second aerial vehicle #1 when the movement route or location of the destination is out of the cell coverage. As a result of the determination, when the destination is located in the first side shadow region, the first aerial vehicle #1 may change the cell coverage by extending the cell coverage to the first side shadow region (i.e., region 1). In addition, the first aerial vehicle #1 may provide a communication service to the second aerial vehicle #1 that has moved to the first side shadow region using the changed cell coverage. In this case, the first aerial vehicle #1 may extend the shadow region for the second side shadow region (i.e., region 2).

That is, the first aerial vehicle #1 may move the cell coverage of the cell by rotating the cell coverage of the cell to the left around a point where the first aerial vehicle #1 is located. In this case, the first aerial vehicle #1 may move the cell coverage of the cell while maintaining a solid angle of the cell coverage of the cell. As a result, the angle that the cell coverage of the cell forms with respect to the ground may be extended from α to β in the second side shadow region (i.e., region 2). Here, α and β mean angles formed by the cell coverage with respect to the ground, and β may be greater than α.

Here, the first aerial vehicle #1 may change the cell coverage of the cell by changing a beam direction of the antenna array provided therewith. Alternatively, the first aerial vehicle #1 may change the cell coverage of the cell by changing the beam direction of the antenna array by performing rolling to rotate around the x-axis or pitching to rotate around the y-axis while levitating in the air.

Meanwhile, the first aerial vehicle #1 may determine whether a beam change is required for the connected second aerial vehicle #2 (S1505). In this case, the first aerial vehicle #1 may determine whether a beam change is required by reflecting the current location of the second aerial vehicle #2 and the changed angle of the cell coverage. As a result of the determination, the first aerial vehicle #1 may maintain a beam providing a communication service to the second aerial vehicle #2 if a beam change is not required.

On the other hand, the first aerial vehicle #1 may change a beam providing a communication service to the second aerial vehicle #2 if a beam change is required (S1506). In addition, the first aerial vehicle #1 may indicate beam switching while notifying the second aerial vehicle #2 of information on the changed beam (S1507). Then, the second aerial vehicle #2 may receive the information of the changed beam from the first aerial vehicle #1, and may receive the indication of beam switching. Thereafter, the first aerial vehicle #1 may provide a communication service to the second aerial vehicle #2 using the changed beam after changing the cell coverage (S1510). Then, the second aerial vehicle #2 may receive the beam transmitted from the first aerial vehicle #1 by performing beam switching with reference to the received changed beam.

Meanwhile, here, the first aerial vehicle #1 determines whether to change the cell coverage when there is a cell change request from the second aerial vehicle #1, but even when there is no cell change request from the second aerial vehicle #1, the first aerial vehicle #1 may perform such the operation. In addition, although the first aerial vehicle #1 determines whether to change the cell coverage based on the movement route or destination location, the first aerial vehicle #1 may change the cell coverage based on the number of aerial vehicles, RLF occurrence, transmission/reception delay, received signal strength, interference with a neighboring cell or beam, and/or the like. In addition, when the cell coverage is changed, the first aerial vehicle #1 may provide information on a time at which the cell coverage is to be changed and reconfiguration parameters of the cell coverage to the second aerial vehicle #1 or the second aerial vehicle #2. Then, the second aerial vehicle #1 or the second aerial vehicle #2 may receive the information on the change time of the cell coverage and the reconfiguration parameters of the cell coverage from the first aerial vehicle #1, and may use them for a subsequent access procedure with the first aerial vehicle #1.

Meanwhile, the second aerial vehicle #2 may transmit the configuration parameters to the neighboring first aerial vehicle #1 (S1511). Then, the first aerial vehicle #1 may receive the configuration parameters from the neighboring first aerial vehicle #2. In addition, the first aerial vehicle #1 may determine a degree of interference (S1512). The first aerial vehicle #1 may reduce the cell coverage to avoid severe interference when the determined degree of interference exceeds a threshold (S1513). In addition, the first aerial vehicle #1 may provide information on a time at which the cell coverage is to be changed and reconfiguration parameters of the cell coverage to the second aerial vehicle #1 or the second aerial vehicle #2 in case of the cell coverage reduction (S1514). Then, the second aerial vehicle #1 or the second aerial vehicle #2 may receive the information on the time at which the cell coverage is to be changed and the reconfiguration parameters of the cell coverage from the first aerial vehicle #1, and may use them for a subsequent access procedure with first aerial vehicle #1.

Meanwhile, the first aerial vehicle #1 may reduce the cell coverage by excluding some beams from among a plurality of beams. Alternatively, the 1-1 aerial vehicle may reduce the cell coverage by reducing a solid angle of the cell coverage. Alternatively, the first aerial vehicle #1 may reduce the cell coverage by reducing the coverage of the beam by adjusting the transmission power.

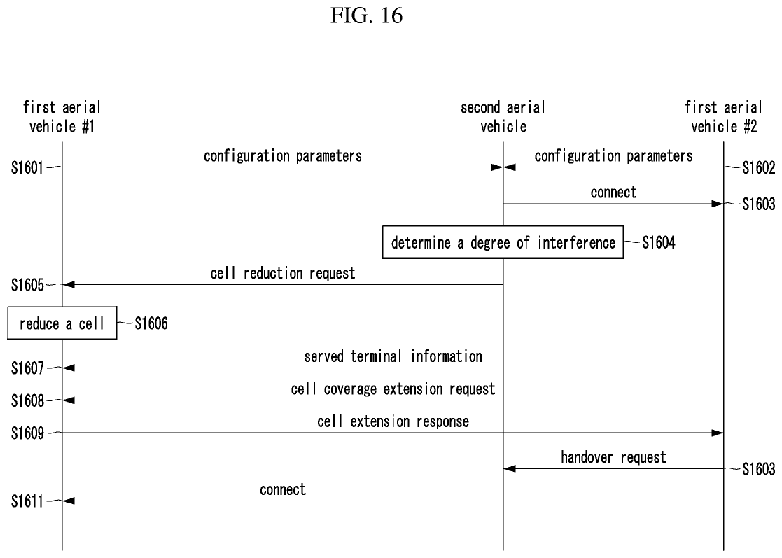

FIG. 16 is a sequence chart illustrating a second exemplary embodiment of a cell coverage configuration method in a communication system.

Referring to FIG. 16, in the cell coverage configuration method, the first aerial vehicle #1 installed at a location not far from the ground may form a cell in a high-altitude air region as shown in FIG. 7. That is, the first aerial vehicle #1 may form a cell in a high altitude direction. In this case, the first aerial vehicle #2 may form a cell in a low altitude air region as shown in FIG. 8. That is, the first aerial vehicle #2 may form a cell in a low altitude direction.

The first aerial vehicle #1 or the first aerial vehicle #2 may configure parameters representatively representing the cell coverage or beam coverage. In this case, the configured parameters may include at least one of a center position parameter, a center angle parameter, a radius parameter, a diameter parameter, a maximum transmission power parameter, a maximum altitude parameter, a minimum altitude parameter, or combinations thereof. In addition, the first aerial vehicle #1 or the first aerial vehicle #2 may transmit the parameters representatively representing the cell coverage or beam coverage to the second aerial vehicle (S1601 and S1602).

In this case, the first aerial vehicle #1 may receive the parameters from the first aerial vehicle #2 and transfer them to the second aerial vehicle. Similarly, the first aerial vehicle #2 may receive the parameters from the first aerial vehicle #1, and transfer them to the second aerial vehicle.

Accordingly, the second aerial vehicle may estimate the cell coverage or beam coverage of the first aerial vehicle #1 based on the received parameters. Also, the second aerial vehicle may estimate the cell coverage or beam coverage of the first aerial vehicle #2 based on the received parameters. As a result, the second aerial vehicle may identify a nearby aerial vehicle among the first aerial vehicle #1 and the first aerial vehicle #2 with reference to the received parameters. As a result of the identification, if the first aerial vehicle #2 is closer than the first aerial vehicle #1, the second aerial vehicle may be connected to the first aerial vehicle #2 adjacent to the second aerial vehicle (S1603).

Meanwhile, the second aerial vehicle may receive severe interference from a signal transmitted from the first aerial vehicle #1 while being connected to the first aerial vehicle #2. Then, the second aerial vehicle may determine a degree of interference (e.g., received signal strength) received from the first aerial vehicle #1 (S1604). The second aerial vehicle may request cell reduction from the first aerial vehicle #1 when the determined degree of interference (e.g., received signal strength) exceeds a threshold (S1605).

In this case, the second aerial vehicle may transmit at least one of RSSI information, RSRP information, RSRQ information, SINR information, or SNR information measured for the first aerial vehicle #1 to the first aerial vehicle #1. In this case, the second aerial vehicle may transmit the configuration parameters received from the first aerial vehicle #2 to the first aerial vehicle #1. In addition, the second aerial vehicle may transmit at least one of RSSI information, RSRP information, RSRQ information, SINR information, or SNR information measured for the first aerial vehicle #2 to the first aerial vehicle #1.

In addition, the second aerial vehicle may provide at least one or more of movement route information, current location information, destination location information, or terminal type information to the first aerial vehicle #1. Here, the location information may include at least one of coordinates, altitude, or elevation angle for the location. In addition, the terminal type information may indicate at least one of a leisure aerial vehicle, an aerial vehicle for a base station, an aircraft, or a UAM. In addition, the second aerial vehicle may determine beam indexes of beams having a degree of interference greater than or equal to a threshold among a plurality of beams transmitted by the first aerial vehicle #1, and inform the first aerial vehicle #1 of the beam indexes.

Meanwhile, the first aerial vehicle #1 may receive a cell reduction request. In addition, the first aerial vehicle #1 may receive at least one of RSSI information, RSRP information, RSRQ information, SINR information, or SNR information measured for the first aerial vehicle #1 from the second aerial vehicle. Also, the first aerial vehicle #1 may receive configuration parameters of the first aerial vehicle #2 from the second aerial vehicle. In addition, the first aerial vehicle #1 may receive at least one of RSSI information, RSRP information, RSRQ information, SINR information, or SNR information measured for the first aerial vehicle #2 from the second aerial vehicle. In addition, the first aerial vehicle #1 may receive at least one of movement route information, current location information, destination location information, and terminal type information from the second aerial vehicle. In addition, the first aerial vehicle #1 may receive beam index information of beams having a degree of interference equal to or greater than a threshold among a plurality of beams. Accordingly, the first aerial vehicle #1 may identify beam indexes of beams interfering with a beam providing a communication service to the first aerial vehicle #2.

In addition, the first aerial vehicle #1 may reduce the cell by reducing the beam coverage by reducing the transmission power of the beams causing interference (S1606). That is, the first aerial vehicle #1 may reduce the transmission power of interfering beams to reduce the cell. As a result, the second aerial vehicle may receive the communication service from the first aerial vehicle #2 without severe interference from the first aerial vehicle #1. Of course, the first aerial vehicle #1 may reduce the cell by reducing the transmission power of all beams to reduce the coverage of all the beams. Also, the first aerial vehicle #1 may reduce the cell by not transmitting the beams causing interference.

Meanwhile, the first aerial vehicle #2 may move away from the second aerial vehicle while providing a communication service to the second aerial vehicle as a serving cell. In this case, the first aerial vehicle #2 may no longer provide a communication service to the second aerial vehicle. As a result, from the perspective of the second aerial vehicle, the serving base station may disappear. In this case, the first aerial vehicle #1 may provide a communication service to the second aerial vehicle through extension of the beam or cell coverage.

In this case, the first aerial vehicle #2 may transmit information on aerial vehicles served by the first aerial vehicle #2 (i.e., served terminal information) to the first aerial vehicle #1 (S1607). The served terminal information may include at least one of RSSI information, RSRP information, RSRQ information, SINR information, or SNR information measured by the served terminal (e.g., the second aerial vehicle) for the first aerial vehicle #2. In addition, the served terminal information may include at least one of RSSI information, RSRP information, RSRQ information, SINR information, or SNR information measured by the served terminal (e.g., the second aerial vehicle) for the first aerial vehicle #2. In addition, the served terminal information may include at least one of a movement route, a current location, a destination location, or a terminal type of the served terminal (e.g., the second aerial vehicle). Accordingly, the first aerial vehicle #1 may receive the served terminal information from the first aerial vehicle #2. That is, the first aerial vehicle #1 may receive information on the second aerial vehicle from the first aerial vehicle #2.

When the first aerial vehicle #2 is no longer able to provide a communication service to the served terminals due to movement, etc., it may request cell coverage extension from the first aerial vehicle #1 by notifying the first aerial vehicle #1 of a serving end time (S1606). Accordingly, the first aerial vehicle #1 may receive the cell coverage extension request including the serving end time from the first aerial vehicle #2. In addition, the first aerial vehicle #1 may determine whether the cell coverage can be extended in order to provide a communication service to the second aerial vehicle after the serving end time. That is, since the first aerial vehicle #1 can increase the transmission power after the serving end time, the first aerial vehicle #1 may determine whether the communication service can be provided to the second aerial vehicle. Alternatively, the first aerial vehicle #1 may determine whether the communication service can be provided to the second aerial vehicle by increasing the transmission power of the beam capable of providing the communication service to the second aerial vehicle after the serving end time.

As a result of the determination, when it is possible to provide a communication service to the second aerial vehicle by extending the cell coverage, the first aerial vehicle #1 may transmit a cell extension response including cell coverage extension information to the first aerial vehicle #2 (S1609). In addition, as a result of the determination, when it is possible to provide a communication service to the second aerial vehicle by extending the beam coverage, the first aerial vehicle #1 may transmit a cell extension response including cell coverage extension information to the first aerial vehicle #2. In this case, the cell coverage extension information may include at least one of extended coverage information and coverage extension time. Here, although the first aerial vehicle #1 transmits the cell coverage extension information to the first aerial vehicle #2 by including it in the cell extension response, the first aerial vehicle #1 may transfer it at a request of the first aerial vehicle #2. That is, the first aerial vehicle #2 may request cell coverage extension information from the first aerial vehicle #1. Then, the first aerial vehicle #1 may receive the cell coverage extension information request from the first aerial vehicle #2. Thereafter, the first aerial vehicle #1 may transmit cell coverage extension information to the first aerial vehicle #2. Then, the first aerial vehicle #2 may receive the cell coverage extension information from the first aerial vehicle #1.

Meanwhile, the first aerial vehicle #2 may request handover or cell reselection to a neighboring cell by transmitting cell coverage extension information further including a serving end time to the served terminal (e.g., the second aerial vehicle) (S1610). Then, the second aerial vehicle may receive the handover request or cell reselection request including the cell coverage extension information further including the serving end time from the first aerial vehicle #2. Then, the second aerial vehicle may perform access and handover to the first aerial vehicle #1 based on the cell coverage extension information (S1611). In this case, the first aerial vehicle #1 may extend the cell coverage according to the serving end time of the first aerial vehicle #2 to provide a communication service to the second aerial vehicle.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1-17. (canceled)

18. A method of a terminal, comprising:
accessing a base station;
receiving measurement-related parameters from the base station;
performing measurement based on the measurement-related parameters; and transmitting a measurement report to the base station,
wherein the measurement-related parameters include at least one height-based parameter, and the terminal performs the measurement by reflecting the at least one height-based parameter.

19. The method according to claim 18, wherein the at least one height-based parameter includes at least one of a maximum altitude parameter or a minimum altitude parameter, and the terminal performs the measurement by reflecting the at least one height-based parameter when the terminal exists in an area corresponding to the maximum altitude parameter or the minimum altitude parameter.

20. The method according to claim 19, wherein the at least one height-based parameter further includes at least one of a center position parameter, a center angle parameter, a radius parameter or a maximum transmission power parameter.

21. The method according to claim 18, wherein the measurement report includes at least one of received signal strength indicator (RSSI) information, reference signal received power (RSRP) information, reference signal received quality (RSRQ) information, signal to interference-plus-noise ratio (SINR) information, or signal-to-noise ratio (SNR) information.

22. The method according to claim 18, further comprising: requesting the base station to change a cell coverage based on the measurement.

23. The method according to claim 18, further comprising:
determining whether a destination is located in a shadow area based on movement toward the destination; and
in response to determining that the destination is located in the shadow area, requesting the base station to change a cell coverage.

24. The method according to claim 23, wherein when the destination is located in a lateral shadow area, the cell coverage is changed by rotation of the cell coverage.

25. The method according to claim 23, wherein when the destination is located in a remote shadow area, the cell coverage is changed by increasing a transmission power of a beam in a direction toward the destination.

26. The method according to claim 18, further comprising:
measuring a reception signal strength for a neighboring cell; and
in response to the measured reception signal strength being equal to or greater than a threshold value, requesting a serving base station of the neighboring cell to reduce a cell coverage.

27. A terminal comprising at least one processor, wherein the at least one processor causes the terminal to perform:
accessing a base station;
receiving measurement-related parameters from the base station;
performing measurement based on the measurement-related parameters; and transmitting a measurement report to the base station,
wherein the measurement-related parameters include at least one height-based parameter, and the terminal performs the measurement by reflecting the at least one height-based parameter.

28. The terminal according to claim 27, wherein the at least one height-based parameter includes at least one of a maximum altitude parameter or a minimum altitude parameter, and the terminal performs the measurement by reflecting the at least one height-based parameter when the terminal exists in an area corresponding to the maximum altitude parameter or the minimum altitude parameter.

29. The terminal according to claim 27, wherein the at least one height-based parameter further includes at least one of a center position parameter, a center angle parameter, a radius parameter or a maximum transmission power parameter.

30. The terminal according to claim 27, wherein the measurement report includes at least one of received signal strength indicator (RSSI) information, reference signal received power (RSRP) information, reference signal received quality (RSRQ) information, signal to interference-plus-noise ratio (SINR) information, or signal-to-noise ratio (SNR) information.

31. The terminal according to claim 27, wherein the at least one processor further causes the terminal to perform: requesting the base station to change a cell coverage based on the measurement.

32. The terminal according to claim 27, wherein the at least one processor further causes the terminal to perform:
determining whether a destination is located in a shadow area based on movement toward the destination; and
in response to determining that the destination is located in the shadow area, requesting the base station to change a cell coverage.

33. The terminal according to claim 32, wherein when the destination is located in a lateral shadow area, the cell coverage is changed by rotation of the cell coverage.

34. The terminal according to claim 32, wherein when the destination is located in a remote shadow area, the cell coverage is changed by increasing a transmission power of a beam in a direction toward the destination.

35. The terminal according to claim 27, wherein the at least one processor further causes the terminal to perform:
measuring a reception signal strength for a neighboring cell; and
in response to the measured reception signal strength being equal to or greater than a threshold value, requesting a serving base station of the neighboring cell to reduce a cell coverage.
